(19) United States
(12) Patent Application Publication
(10) Pub. No.: US 2023/0367921 A1
(43) Pub. Date: Nov. 16, 2023

(54) POWERTRAIN ARCHITECTURE DESIGN TOOL

(71) Applicant: Caterpillar Inc., Peoria, IL (US)

(72) Inventor: Gavin WILLIAMS, Stamford (GB)

(73) Assignee: Caterpillar Inc., Peoria, IL (US)

(21) Appl. No.: 18/027,176

(22) PCT Filed: Sep. 2, 2021
(86) PCT No.: PCT/US2021/048788

§ 371 Date: Mar. 20, 2023

(30) Foreign Application Priority Data
Sep. 22, 2020 (GB) 2014950.6

(51) Int. Cl. G06F 30/15

(52) U.S. Cl. CPC G06F 30/15

(57) ABSTRACT

A computer implemented design tool configured to design a powertrain is provided. The design tool utilises and input file comprising architecture selection constraints and load requirements for the powertrain to be designed along with a generic powertrain component library. The generic powertrain component library comprises configurable models of powertrain components. The design tool generates candidate powertrain architectures based on the input file and the generic powertrain component library. The design tool also generated candidate parameters for each of the components in each candidate powertrain architecture. The design tool is configured to calculate optimised component parameters for each candidate powertrain architecture. The design tool then outputs an optimised powertrain architecture based on the candidate powertrain architectures evaluated.

### FIELD OF THE DISCLOSURE

This disclosure relates to a powertrain. In particular, the present disclosure relates to a design tool for the design of a powertrain, such as a powertrain comprising at least one of an internal combustion engine, a hydrogen fuel cell, or a battery.

### BACKGROUND

A powertrain is a system which includes one or more components which generate power (power sources) and one or more components which are arranged to deliver that power in a desired form (power sink). For example, for a motor vehicle, a powertrain may comprise an internal combustion engine, a gear box (also known as a transmission), a drive shaft, a differential, and a set of wheels which are in contact with a driving surface.

By way of example, FIG. 1A shows a schematic example of a powertrain for a motor vehicle. In this example, the powertrain comprises a single power source, the internal combustion engine. The internal combustion engine is connected to a clutch and a gearbox, which is in turn connected to a drive output (e.g. wheels). In other powertrains, components, such as the clutch and gearbox, may not be present. For example, in FIG. 1B a schematic diagram of a powertrain comprising an internal combustion engine and a drive output is shown (i.e. a direct drive powertrain).

In other powertrains, more than one power source may be present. For example, in a hybrid powertrain, there may be a plurality of power sources present, such as an internal combustion engine and an electric motor/generator. For example, FIGS. 1C and 1D are examples of hybrid powertrains including an internal combustion engine and a motor generator. In the examples of FIGS. 1C and 1D, a gearbox and a clutch are also provided. It will be appreciated from FIGS. 1C and 1D that the arrangement of the clutch, gearbox and motor generator may be varied depending on the powertrain architecture.

It will be appreciated from FIGS. 1A to 1D that the architecture of a powertrain can vary from relatively simple designs to more complex architectures with multiple power sources and connecting components. Ultimately, all the designs shown in FIGS. 1A to 1D output power to a drive, such as wheels for a vehicle. Deciding on the most appropriate powertrain architecture for a given design problem is challenging. For each of the powertrain architectures shown in FIGS. 1A to 1D there are numerous design parameters which can be chosen, in addition to the variations in powertrain architecture.

For powertrains comprising a plurality of powertrains, such as hybrid powertrains, the presence of multiple power sources increases the complexity of the design problem. The complexity is further increased where the powertrains operate in different energy domains. Furthermore, as the design of powertrains, in particular hybrid powertrains becomes more complex, the number of possible arrangements of the powertrain components increases significantly. For example, for a hybrid powertrain comprising an internal combustion engine and an electric motor, multiple configurations of the power sources in either parallel or series are possible.

Assessing the suitability of a particular powertrain design to meet a design problem depends on the powertrain design, and on also the controller design used to control the powertrain. Comparing the suitability of different designs can be difficult, as the metric used to compare the design may influence the conclusions. Often, many assumptions about the properties of the powertrain and controller are made as part of a design process. As such, it can be challenging to follow a design process that is not inherently biased towards one particular form of powertrain design.

### SUMMARY

According to a first aspect of the disclosure, a method for designing a powertrain using a design tool implemented on a computer is provided. The method comprises providing an input file to the design tool, the input file comprising architecture selection constraints and load requirements for the powertrain to be designed.

The method of the first aspect also comprises providing a generic powertrain component library. The generic powertrain component library comprises a plurality of configurable first, second, third, and fourth component models. N power source models are configurable from the configurable first component models based on first component parameters. Each configurable first component model is configured to receive at least one of a plurality of first component specific inputs and to calculate an effort output or flow output based on the at least one of the plurality of first component specific inputs. M power sink models are configurable from the plurality of configurable second component models based on second component parameters. Each configurable second component model is configured to receive at least one of a plurality of second component specific inputs and to calculate an effort output or flow output based on at least one of the plurality of second component specific inputs. At least one inertance coupling model is configurable from the plurality of configurable third component models based on third component parameters. Each configurable third component model is configured to receive a plurality of effort inputs and to calculate a flow output based on the effort inputs. At least one compliance based coupling model is configurable from the plurality of configurable fourth component models based on fourth component parameters. Each fourth component model is configured to receive a plurality of flow inputs and to calculate an effort output. X coupling models may be configured from the plurality of configurable third and fourth component models.

According to the method of the first aspect, the design tool generates a plurality of candidate powertrain architectures based on the generic powertrain component library, and the load requirements and architecture selection constraints of the input file. Each candidate powertrain architecture comprises N power source models with first component specific inputs, M power sink models with second component specific inputs, and X coupling models.

According to the method of the first aspect, for each candidate powertrain architecture:
i) The design tool generates a connections model of the N power source models, M power sink models and X coupling models which is representative of the candidate powertrain architecture comprising flow weight parameters and effort weight parameters. The flow weight parameters define any flow connections from the flow outputs of the N power source models, the flow outputs of the M power sink models, and the flow outputs of the inertance coupling models of the X couplings to the flow inputs of the compliance based coupling models of the X couplings of the model architecture. The effort weight parameters define any effort connections from the effort outputs of the N power source models, the effort outputs of the M power sink models, and the effort outputs of the compliance based coupling models of the X couplings to the effort inputs of the inertance coupling models of the X coupling models of the model architecture.
ii) The design tool generates a model of the candidate powertrain architecture by providing candidate first, second, third and fourth component parameters for the N power source models, M power sink models, and X coupling models of the candidate powertrain architecture.
iii) The design tool evaluates the model of the candidate powertrain architecture based on the load requirements of the input file and generates a cost associated with the candidate powertrain architecture and the candidate first, second, third, and fourth component parameters.
iv) The design tool calculates optimised first, second, third and fourth component parameters for the candidate powertrain architecture by optimising the candidate first, second, third, and fourth component parameters based on the cost associated with the candidate powertrain architecture and the candidate first, second, third, and fourth component parameters. The design tool outputs an optimised powertrain architecture having optimised first, second, third and fourth component parameters based on the optimised first, second, third and fourth component parameters of each candidate powertrain architecture.

According to a method of the first aspect, the design tool generates an optimised powertrain architecture having optimised component parameters. The optimised powertrain architecture is optimised based on a load requirements and powertrain architecture constrains specified in the input file.

The design tool is configured to consider a wide range of different possible design solutions in order to arrive at the optimised powertrain architecture. As such, the design tool can consider significantly more candidate solutions than would be possible by a user working “by hand”. Furthermore, the design tool is configured to consider solutions without any preconceived bias. As such, the design tool is capable of identifying and evaluating candidate solutions which may not be considered by a user working “by hand” due to past experience and traditional powertrain design conventions.

The design tool is configured to design and evaluate a wide range of possible powertrain architectures based on the component models within a generic powertrain component library. As such, the design tool may generate a powertrain architecture and a powertrain model of a powertrain comprising M power source, N power sinks and X couplings, where M, N and X are all integers. Accordingly, the design tool can be utilised to design a wide range of powertrains for different applications. For example, the design tool may be used to design and optimise any of the powertrains shown in FIGS. 1A to 1D.

In some embodiments, the load requirements of the input file comprise a reference load for the powertrain.

In some embodiments, the architecture selection constraints of the input file comprise one or more of: a minimum number of power sources constraint, a maximum number of power sources constraint, a minimum number of power sinks constraint, a maximum number of power sinks constrain, a minimum number of couplings constraint, and a maximum number of couplings constraint.

In some embodiments, each configurable third component model comprises a first effort sum junction configurable to calculate a net effort input for the third component model based on at least one of: the effort output from one or more power source models, the effort output from one or more power sink models, and the effort output from one or more compliance based coupling models, wherein the flow output is calculated based on the net effort input.

In some embodiments, each configurable third component model comprises an effort scaling module configurable to scale at least one of: the effort output from one or more power source models, the effort output from one or more power sink models, and the effort output from one or more compliance based coupling models based on a first scaling parameter and to scale the flow output calculated by the configurable third component model by a first complementary scaling parameter, wherein the first scaling parameter is provided by the design tool when generating the model of each candidate powertrain architecture; and the design tool calculates an optimised first scaling parameter based on the cost associated with the candidate powertrain architecture and the candidate first, second, third, and fourth component parameters.

In some embodiments, the net effort input calculated by the first effort sum junction is based on efforts in the same energy domain.

In some embodiments, each configurable fourth component model comprises a first flow sum junction configured to calculate the net flow input for the fourth component model based at least one of: the flow output from one or more power source models, the flow output from one or more power sink models, and the flow output from one or more inertance coupling models.

In some embodiments, each configurable fourth component model comprises a flow scaling module configurable to scale at least one of: the flow output from one or more power source models, the flow output from one or more power sink models, and the flow output from one or more effort based coupling models based on a second scaling parameter and to scale the effort output calculated by the configurable fourth component model by a second complementary scaling parameter. In some embodiments, the second scaling parameter is provided by the design tool when generating the model of each candidate powertrain architecture. In some embodiments, the design tool calculates an optimised second scaling parameter based on the cost associated with the candidate powertrain architecture and the candidate first, second, third, and fourth component parameters.

In some embodiments, generating a candidate powertrain architecture comprises: selecting a set of first, second, third and/or fourth component models from the generic component library based on the architecture selection constraints.

In some embodiments, generating a connections model of the N power source models, M power sink models and X coupling models for each candidate powertrain architecture comprises generating a causal relationship between the N power source models, M power sink models and X coupling models.

In some embodiments, the design tool optimises the candidate first, second, third, and fourth component parameters using a stratified sampling strategy.

In some embodiments, the design tool further optimises the candidate first, second, third, and fourth component parameters following the stratified sampling strategy using a line search strategy.

In some embodiments, the design tool calculates a response of the model of the candidate powertrain architecture to the reference load and evaluates the response of the model of the candidate powertrain architecture based on the load requirements.

According to a second aspect of the disclosure, a computer-implemented design tool for designing a powertrain is provided. The design tool is configured to receive an input file, the input file comprising architecture selection constraints and load requirements for the powertrain to be designed. The design tool is configured to receive a generic powertrain component library. The generic powertrain library comprises a plurality of configurable first, second, third, and fourth component models. N power source models are configurable from the configurable first component models based on first component parameters. Each configurable first component model is configured to receive at least one of a plurality of first component specific inputs and to calculate an effort output or flow output based on the at least one of the plurality of first component specific inputs. M power sink models are configurable from the plurality of configurable second component models based on second component parameters. Each configurable second component model is configured to receive at least one of a plurality of second component specific inputs and to calculate an effort output or flow output based on at least one of the plurality of second component specific inputs. At least one inertance coupling model is configurable from the plurality of configurable third component models based on third component parameters. Each configurable third component model is configured to receive a plurality of effort inputs and to calculate a flow output based on the effort inputs. At least one compliance based coupling model is configurable from the plurality of configurable fourth component models based on fourth component parameters. Each fourth component model is configured to receive a plurality of flow inputs and to calculate an effort output. X coupling models may be configured from the plurality of configurable third and fourth component models.

The design tool comprising according to the second aspect comprises an architecture generation module. The architecture generation module is configured to generate a plurality of candidate powertrain architectures based on the generic powertrain component library, and the load requirements and architecture selection constraints of the input file. Each candidate powertrain architecture comprises N power source models with first component specific inputs, M power sink models with second component specific inputs, and X coupling models with third and/or fourth component specific inputs;

For each candidate powertrain architecture:
i) the architecture generation module is configured to generate a connections model of the N power source models, M power sink models and X coupling models which is representative of the candidate powertrain architecture comprising flow weight parameters and effort weight parameters. The flow weight parameters define any flow connections from the flow outputs of the N power source models, the flow outputs of the M power sink models, and the flow outputs of the inertance coupling models of the X couplings to the flow inputs of the compliance based coupling models of the X couplings of the model architecture. The effort weight parameters define any effort connections from the effort outputs of the N power source models, the effort outputs of the M power sink models, and the effort outputs of the compliance based coupling models of the X couplings to the effort inputs of the inertance coupling models of the X coupling models of the model architecture.
ii) The design tool is configured to generate a model of the candidate powertrain architecture by providing candidate first, second, third and fourth component parameters for the N power source models, M power sink models, and X coupling models of the candidate powertrain architecture;
iii) A model evaluation module of the design tool is configured to evaluate the model of the candidate powertrain architecture based on the load requirements of the input file and generates a cost associated with the candidate powertrain architecture and the candidate first, second, third, and fourth component parameters; and
iv) The design tool is configured to calculate optimised first, second, third and fourth component parameters for the candidate powertrain architecture by optimising the candidate first, second, third, and fourth component parameters based on the cost associated with the candidate powertrain architecture and the candidate first, second, third, and fourth component parameters. The design tool is configured to output an optimised powertrain architecture having optimised first, second, third and fourth component parameters based on the optimised first, second, third and fourth component parameters of each candidate powertrain architecture.

As such, the design tool of the second aspect may carry out the method according to the first aspect of the disclosure. Accordingly, the design tool of the second aspect of the disclosure may include any of the optional features of the first aspect and any associated advantages.

### BRIEF DESCRIPTION OF THE FIGURES

Embodiments of the present disclosure will now be described, by way of example only, with reference to the accompanying figures in which:

FIG. 1A shows a schematic diagram of an example of a first powertrain;

FIG. 1B shows a schematic diagram of an example of a second powertrain;

FIG. 1C shows a schematic diagram of an example of a third powertrain;

FIG. 1D shows a schematic diagram of an example of a fourth powertrain;

FIG. 2 shows a diagram of a tetrahedron of state;

FIG. 3 shows a table of various states in different energy domains;

FIG. 4 shows an overview diagram of the design tool according to an embodiment of the disclosure;

FIG. 5 shows a diagram of the generic powertrain component library and the connections that may be specified between each of the component models;

FIG. 6A shows a schematic diagram of a first powertrain according to this disclosure;

FIG. 6B shows a further schematic diagram of a generator powertrain with a non-rigid drive shaft;

FIG. 7 shows a block diagram of one example of a generic linear inertance coupling model;

FIG. 8a shows a diagram of a plurality of candidate powertrain architectures that may be generated by the design tool according to an embodiment of the disclosure

FIG. 8b shows a vector of possible combinations of components for the example of FIG. 8a

FIG. 8c shows the possible permutations of connections for the four component combination of FIG. 8a and the effect of isomorphism reduction;

FIG. 9 shows an annotated diagram of a powertrain showing the causality for the generation of a forward facing model;

FIG. 10a shows an annotated diagram of a powertrain showing the causality for the generation of a backward facing model;

FIG. 10b shows an annotated diagram of a powertrain showing the causality for the generation of a dynamic model;

FIG. 11A shows a schematic diagram of a model of a candidate powertrain architecture generated by the design tool which is representative of a generator;

FIG. 11B shows a further diagram of another possible model of a candidate powertrain architecture generated by the design tool which is representative of a generator where the drive shaft is assumed to not be rigid;

FIG. 12 shows a diagram of a candidate powertrain architecture configured to provide a powertrain model of the second powertrain;

FIG. 13 shows a schematic diagram of model of a candidate powertrain architecture generated by the design tool which is representative of a second powertrain according to this disclosure;

FIG. 14 shows a block diagram of one example of a generic linear compliance-based coupling model;

FIG. 15 shows a model of a candidate powertrain architecture generated by the design tool which is representative of a third powertrain according to this disclosure;

FIG. 16 shows a schematic diagram of a third powertrain according to this disclosure;

FIG. 17 shows a diagram of a generic inertance coupling model including an effort scaling module;

FIG. 18 shows a model of a candidate powertrain architecture generated by the design tool which is representative of a fourth powertrain according to this disclosure;

FIG. 19 shows a schematic diagram of a fourth powertrain according to this disclosure;

FIG. 20 shows a graph of a reference load according to this disclosure;

FIG. 21 shows a graph of a reference load and a response of a model of a candidate powertrain architecture;

FIG. 22 shows a graph of a cost space for a set of parameters according to this disclosure.

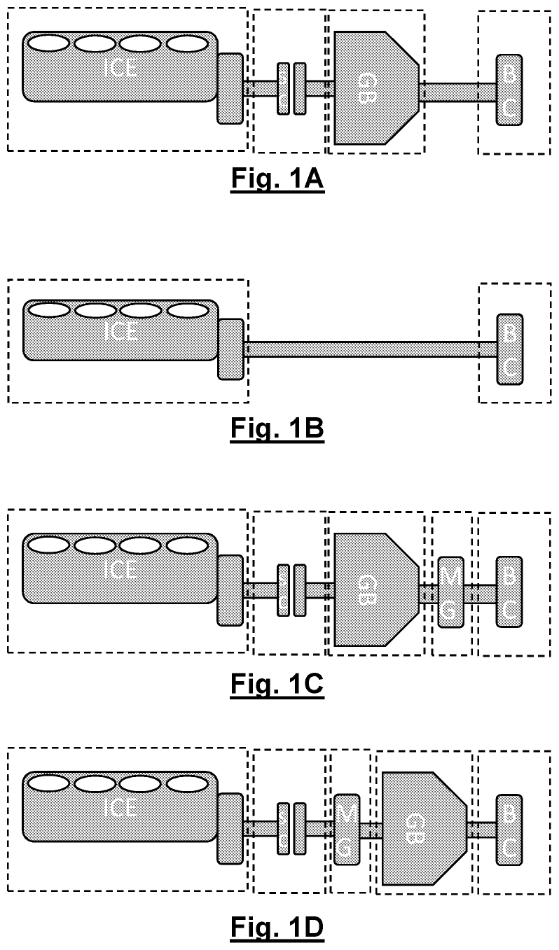

### DETAILED DESCRIPTION

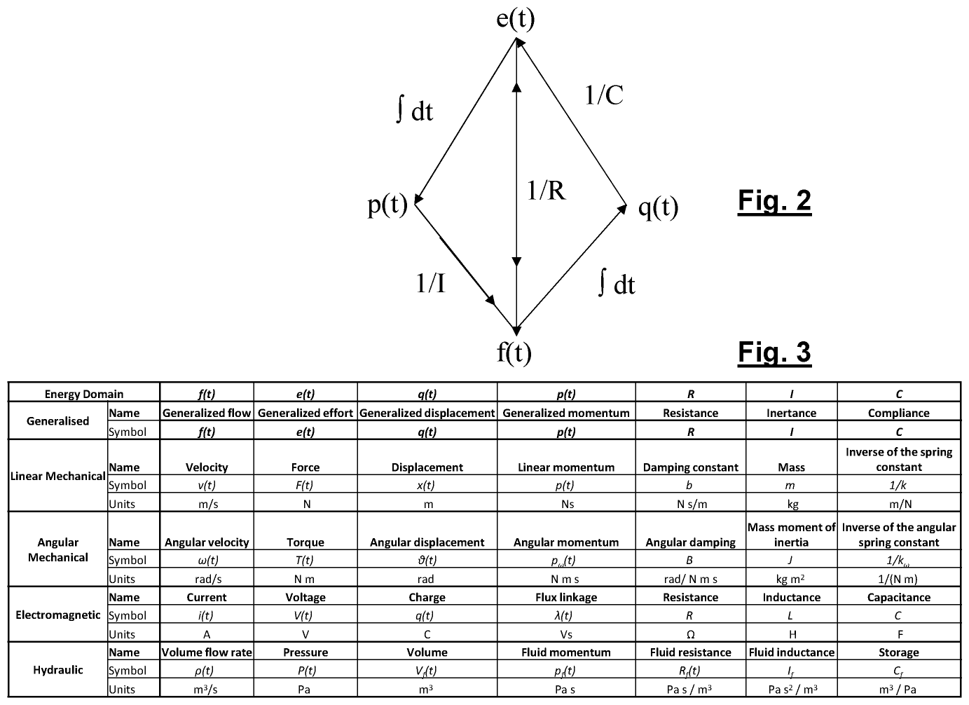

The design tool of this disclosure is able to design and optimise a wide range of powertrains, including powertrains that operate in a range of energy domains (e.g. hybrid powertrains). This is achieved by modelling the transfer of physical energy through the powertrain using the concept of efforts and flows from Bond Graph Theory. Bond graph theory models energy transfer in a dynamic system based on the tetrahedron of state. In general, the dynamics of a physical system can be represented by an effort (e(t)), a flow (f(t)), a momentum (p(t)) and a displacement (q(t)). The relationship between these states can be shown in a tetrahedron of state, such as the tetrahedron of state shown in FIG. 2. According to the tetrahedron of state, starting from one state, any of the other states can be calculated based on the relationships set out in the tetrahedron of state.

The tetrahedron of state can be applied to various energy domains. For example, FIG. 3 sets out the equivalent terms in a selection of energy domains. For example, in the angular mechanical energy domain, a torque is a form of effort, whilst an angular velocity is a flow. By applying the principal of conservation of energy, the physical relationship between various components of a powertrain (including hybrid powertrains) can be modelled by accounting for the transfer of energy through the powertrain via integral causality, e.g. efforts to flows, flows to efforts. The product of effort and flow is power, or energy per unit time.

### Overview of the Design Tool

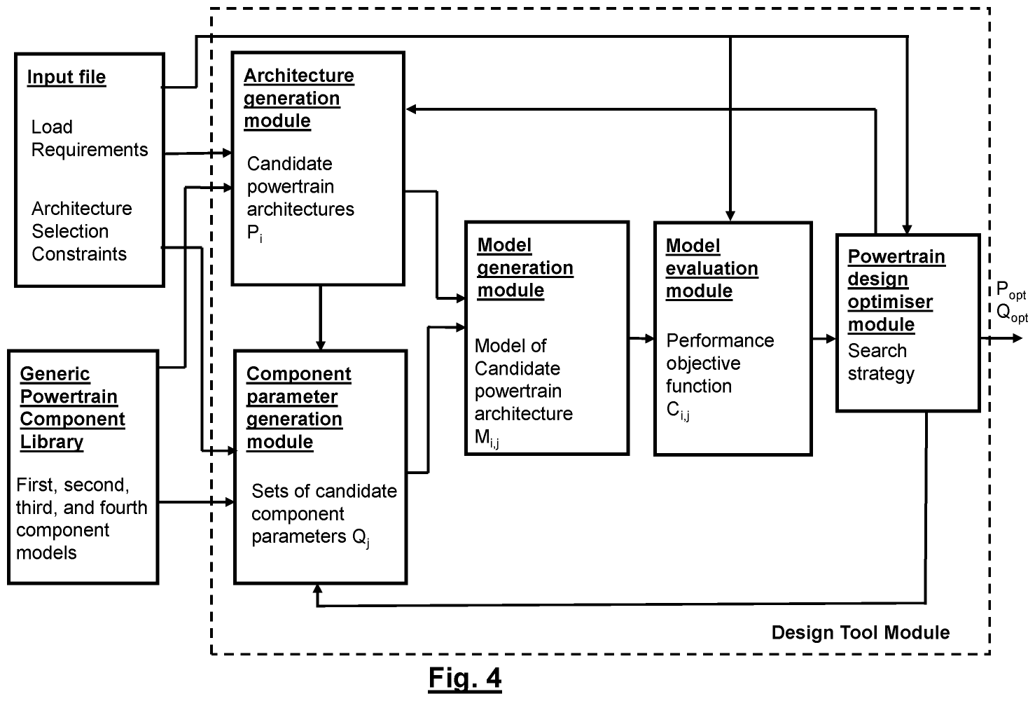

An overview of the design tool is shown in FIG. 4. FIG. 4 shows a diagram of the input file, the generic powertrain component library, and the design tool module. The design tool module includes an architecture generation module, a component parameter generation module, a model generation module, a model evaluation module, and a powertrain design optimiser module. The design tool may be configured to generate an optimised powertrain architecture having optimised component parameters. The optimised powertrain architecture is optimised based on a load requirements and powertrain architecture constraints specified in the input file.

The design tool is configured to evaluate a wide range of possible design solutions in order to arrive at the optimised powertrain architecture. As such, the design tool can consider significantly more candidate solutions than would be possible by a user working “by hand”. Furthermore, the design tool is configured to consider solutions without any preconceived bias. As such, the design tool is capable of identifying and evaluating candidate solutions which may not be considered by a user working “by hand” due to past experience and traditional powertrain design conventions.

The design tool is configured to design and evaluate a range of possible powertrain architectures based on the component models within a generic powertrain component library. As such, the design tool may generate a powertrain architecture and a powertrain model of a powertrain comprising N power sources, M power sinks and X couplings, where M, N and X are all integers.

In order to arrive at an optimised powertrain architecture the design tool is configured to consider a plurality of different powertrain architectures (candidate powertrain architectures) that may fulfil the load requirements and the architecture selection constraints. For example, the design tool may consider candidate powertrain architectures including one power source, two power sources, or more. Where a plurality of power sources are included in a candidate powertrain architecture, the design tool may consider different types of power source such as internal combustion engines, motor-generators etc. As such, the design tool may consider a wide range of possible candidate powertrain architectures, including hybrid powertrain architectures in order to arrive at the optimised powertrain architecture. The candidate powertrain architectures are generated by the architecture generation module of the design tool, which is discussed in more detail below.

The design tool is also configured to optimise the components which make up the optimised powertrain architecture. As such, the design tool may select and optimise various parameters for each component of the powertrain. That is to say, the design tool may optimise the design parameters for each component of a powertrain architecture. The design parameters for each component of a powertrain architecture may be optimised by selection of the parameters for each component model in the generic powertrain component library. The component parameter generation module generates the component parameters for each component module, which is discussed in more detail below.

### Input File

The input file includes load requirements and architecture selection constraints for the powertrain to be designed by the design tool. As such, the input file specifies the design requirements (or specification) for the powertrain to be designed. The information within the input file may provide information regarding component specific inputs for the component models to be used by the design tool.

The load requirements include information defining the load that the powertrain should be able to deliver. The load requirements can be specified in a number of different manners. For example, in some embodiments, a reference load may be provided. In some embodiments, a speed torque boundary may be provided, or a distance travelled and road load model may be provided.

For example where a reference load is provided a speed and torque profile may be generated vs time e.g. for the drive wheel torques of a vehicle. The reference speed and reference torque is fixed vs time. The measure of success used by the design tool may be how well the candidate powertrain architecture adheres to the speed and torque profile. A less successful candidate powertrain architecture may have reduced torque with respect to the profile. A more successful candidate powertrain architecture may provide the requested torque at the desired speed throughout the test. Each candidate powertrain architecture is assessed over the same test duration.

A reference load may also be provided which more closely resembles a realistic use scenario. For example where the powertrain to be designed involves a vehicle, the reference load may define a speed target and distance travelled. The performance of each candidate powertrain architecture may be modelled as part of a vehicle model (provided as part of the load requirements). In this system a weaker candidate powertrain architecture may cover the same distance, but take longer to do it, for example a slower hill climb. This method could also take into account a mass penalty associated with changes in the architecture of each candidate powertrain candidate has on the overall vehicle mass for example, i.e. the total mass is partitioned into the powertrain mass and glider mass.

It will be appreciated that while the above examples consider reference loads with respect to the drive of a vehicle, for many powertrains there may also be other load sinks/source. For example, the design tool may take into account reference loads including vehicle traction loads, boom raise and bucket tilt loads and the like.

In some embodiments, a reference load may include a transient response for speed and torque. By providing a transient response as part of the load requirements, the load capability of the candidate powertrains can be assessed against the transient response and penalised if not met.

The architecture selection constraints specify any constraints for the design of the powertrain architecture that may be desired by the user. The architecture selection constraints may include information defining one or more of: constraints on the number of internal combustion engine (maximum, minimum, or fixed number), internal combustion engine swept volume, constraints on number of motor/generators, constraints on gear options (e.g. gear ratios available), constraints on batteries (e.g. battery size available, battery voltage available). As such, the architecture selection constraints may in some embodiments be used to specify parameters for one or more components to be used in the powertrain to be designed.

In some embodiments, the architecture selection constraints may include information defining parameters of various powertrain components that are available to be used in the design of the powertrain. As such, the architecture selection constraints may be used to specify parameters for pre-existing powertrain components. That is to say, the architecture selection constraints may be used to prompt the design to consider one or more “off the shelf” components when arriving at the optimised powertrain architecture. For example, the architecture selection constraints may be used to specify component parameters for a plurality of different internal combustion engines (e.g. having different engine swept volume). As such, the architecture selection constraints may be used to restrict the design tool to considering only specific components for one or more of the parts forming the optimised powertrain architecture.

### Generic Powertrain Component Library

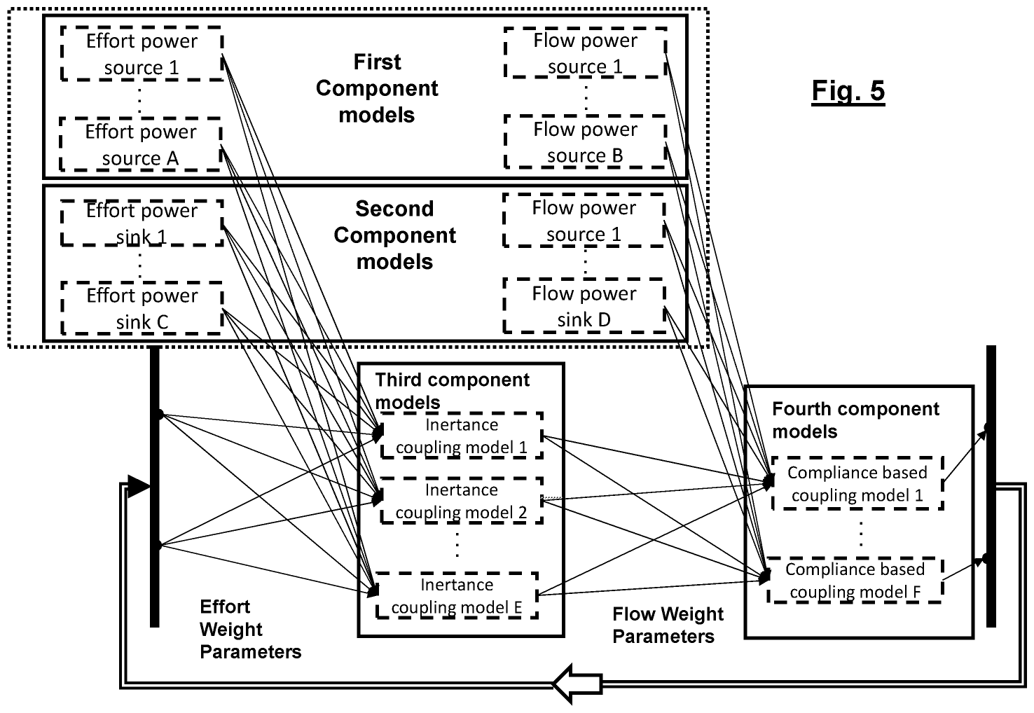

FIG. 5 shows a diagram of the generic powertrain component library and the connections that may be specified between each of the component models. As such, FIG. 5 provides a schematic diagram of the possible powertrain architectures that may be generated by the design tool.

FIG. 5 shows a representation of the first, second third, and fourth component models in the generic powertrain component library.

### First Component Models

The first component models shown in FIG. 5 are configurable to represent flow power sources or effort power sources of a powertrain. As such, the configurable first component models comprise generic flow power source models and generic effort power source models which may be configured to represent specific power sources of a specific powertrain. As shown in FIG. 5, the generic powertrain component library may comprise A generic effort power source models and B generic flow power source models, where A and B are non-zero positive integers.

Each generic effort power source model is a generic model of a component which generates power in the form of an effort. Examples of an effort power source include an internal combustion engine generating a torque output, or a battery generating a voltage output. The generic powertrain component library includes one or more models for each generic component. That is to say, the generic powertrain component library may include a number of different models for a generic component (e.g. an internal combustion engine) from which the most appropriate model may be selected. For example, in one embodiment, the generic powertrain component library may comprise: a first generic internal combustion engine model, a second generic internal combustion engine model, a third generic internal combustion engine model, a first motor-generator model, a second motor-generator model, a first battery model, and a second battery model. In total, in the embodiment of FIG. 4, there are A generic effort power source models.

Each generic effort power source model of a component is configured to calculate an effort output for that component based on at least one component specific input. For example, for a generic internal combustion engine model, the generic internal combustion engine model may be configured to receive component specific inputs providing information relating to the variables Fuel Quantity, Exhaust gas recirculation (EGR), Start of Injection (SOI), Fuel Rail Pressure (FRP), Shot Mode, Turbo Boost, and Engine Speed. A generic motor generator model may be configured to receive component specific inputs providing information relating to the variables: Current. The component specific inputs may be derived from the input file. For example, where a reference load is provided as part of the input file, component specific inputs for a power source (e.g. an internal combustion engine) may be derived from the reference load. Alternatively, component specific inputs may be provided by the output of another configurable component model or a controller forming part of the model of a candidate powertrain architecture (discussed below).

A number of first configurable component models may be provided for each type of effort power source wherein the component specific inputs utilised are different. Thus, the generic powertrain component library may be adapted to provide suitable models for a variety of different effort power sources where a range of inputs are available for control.

In order to configure each generic effort power source model to reflect the performance of the effort power source it is intended to model, each generic effort power source model may be configured to receive one or more first component parameters. The first component parameters provide information relating to the properties of each effort power source component. For example, for a generic internal combustion engine model, the effort power source model may be configured to receive first component parameters selected from a group including: Internal combustion engine efficiency parameters, Turbocharger control map parameters, Number of engine cylinders. The internal combustion engine efficiency parameters may include a range of different efficiency parameters depending on the internal combustion engine, for example including at least one of: Volumetric efficiency, gross fuel conversion efficiency, exhaust fuel conversion efficiency. For a generic motor generator model (e.g. representative of a DC motor), the model may be configured to receive first component parameters including one or more of: counter EMF constant (k_{b}), and magnetic flux of the motor.

The first component parameters for a generic effort power source model (or indeed any configurable first, second, third, or fourth component model) may be provided as a structured variable. The structured variable may also include any architecture selection constraints which relate to the component. Providing the component parameters (and optionally the architecture selection constraints) in such a form makes the component parameters easier to pass between different modules of the design tool. For example, in some embodiments, a structure variable including component parameters and architecture selection constraints for an internal combustion engine may comprise:

Component Parameters:
Engine.EngineModel.Params.VE
Engine.EngineModel.Params.FCE

Architecture Selection Constraints:
Engine. EngineModel.Constraints.SpeedMax=2200
.SpeedMin=800
.MaxTorque=f(Speed)
.MinTorque=f(Speed)
Engine. EngineModel.Mass=400
Engine. EngineModel.EconomicCost=5000

In the above example, structured variable component parameters for volumetric efficiency (VE) and gross fuel conversion efficiency (FCE) are shown. Architecture selection constraints for maximum engine speed (SpeedMax), minimum engine speed (SpeedMin), maximum engine torque (MaxTorque), minimum engine torque (MinTorque), Engine Mass (Mass) and Economic Cost are also shown. It will be appreciated that the above list are only some of the possible component parameters and architecture selection constraints that may be included as part of a structured variable for a powertrain component used by the design tool.

The generic flow power source models are generic models of a components which generate power in the form of a flow. Examples of flow power sources include a synchronous motor outputting a constant angular velocity, a massive body travelling at a constant speed, water flow for driving a hydro-electric generator, or a hydraulic pump outputting a constant fluid flow. The generic powertrain component library includes one or more models for each generic flow power source component. That is to say, the generic powertrain component library may include a number of different models for a generic flow power source component (e.g. a synchronous motor) from which the most appropriate model may be selected.

Each generic flow power source model of a component is configured to calculate a flow output for that component based on at least one component specific input. For example, a generic synchronous motor model may be configured to receive a component specific input providing information relating to the variable: AC current frequency, from which the flow output may be calculated. Similar to the effort power source models described above, a number of generic component models may be provided for each type of flow power source wherein the component specific inputs utilised are different. Thus, the generic powertrain component library may be adapted to provide suitable models for a variety of different powertrains where a range of inputs are available.

In order to configure each generic flow power source model to reflect the performance of the flow power source to be modelled, each generic flow power source model may be configured to receive one or more first component parameters. The first component parameters provide information relating to the properties of each flow power source component in a powertrain. For example, for a hydraulic pump, first component parameters may include one or more of: volumetric efficiency, and the stroked volume of the hydraulic pump.

The configurable first component models in the generic powertrain component library comprise a variety of different models of various power source which may be used in a range of different powertrains. By providing a range of different generic power source models, the design tool can be used to design a wide range of different powertrains. Furthermore, as each configurable first component model is arranged to receive first component parameters, each configurable first component model can be configured to model different sizes/versions of a power source.

### Configurable Second Component Models

The configurable second component models shown in FIG. 5 are configurable to represent flow power sinks or effort power sinks of a powertrain. As such, the configurable second component models comprise generic flow power sink models and generic effort power sink models which may be configured to represent specific power sources of a specific powertrain. As shown in FIG. 5, the generic powertrain component library may comprise C generic effort power sink models and D generic flow power sink models, where C and D are non-zero positive integers.

The generic effort power sink models and generic flow power sink models are models of components which generally consume power. It will be appreciated that there are some components, for example a motor-generator, which may consume or generate power and as such may interchangeably act as a power source or power sink. Such components may be modelled in the generic component library as a first component model, a second component model, or both. In general, the design tool considers a component (which can be either a power source or power sink) to be a power source or power sink based on its dominant use case. That is to say, a component which is to act as power source for the majority of time is considered to be a power source. A components which is to act as a power sink for the majority of time is considered to be a power sink.

Each generic effort power sink model is a generic model of a component which consumes power in the form of an effort. Examples of an effort power sink include the drive output of a vehicle (e.g. wheels in contact with the ground), or a motor-generator. The generic powertrain component library includes one or models for each generic component. That is to say, the generic powertrain component library may include a number of different models for a generic component (e.g. a drive output) from which the most appropriate model may be selected. For example, in one embodiment, the generic powertrain component library may comprise: a first generic drive model, a second generic drive model, a third generic drive model, a first motor-generator model, a second motor-generator model. In total, in the embodiment of FIG. 4, there are C generic effort power sink models.

Each generic effort power sink model of a component is configured to calculate an effort output for that component based on at least one second component specific input provided. As the specific power sink will often be consuming power, the effort output calculated by the generic effort power sink model may be negative. For example, for a generic drive model of a vehicle, the generic drive model may be configured to receive component specific inputs providing information relating to the variables: vehicle speed, wind resistance, and gradient. A generic motor generator model may be configured to receive second component specific inputs providing information relating to the variables: current output, voltage output. The component specific inputs may be derived from the input file. For example, where a reference load is provided as part of the input file, component specific inputs for a power sink may be derived from the reference load. Alternatively, component specific inputs may be provided by the output of another configurable component model or a controller forming part of the model of a candidate powertrain architecture (discussed below).

A number of generic effort power sink models may be provided for each type of effort power sink. Thus, each type of effort power sink may be modelled using different component specific inputs. Thus, the generic powertrain component library may be adapted to provide suitable models for a variety of different effort power sinks where a range of second component specific inputs are available.

In order to configure each generic effort power sink model to reflect the performance of the specific effort power sink to be modelled, each generic effort power sink model may be configured to receive one or more second component parameters. The second component parameters provide information relating to the properties of each effort power sink component in the powertrain architecture. For example, for a generic drive model, the model may be configured to receive second component parameters selected from a group including: drive efficiency, coefficient of friction etc. For a generic motor generator model (e.g. representative of a DC motor), the model may be configured to receive second component parameters including: counter EMF constant (k_{b}), magnetic flux of the motor.

The generic flow power sink models are generic models of components which consume power in the form of a flow. Examples of flow power sinks include the national grid, which receives electrical power at a generally constant frequency. The generic powertrain component library includes one or more models for each generic flow power sink component. That is to say, the generic powertrain component library may include a number of different models for a generic flow power sink component (e.g. the national grid) from which the most appropriate model may be selected.

Each generic flow power sink model of a component is configured to calculate a flow output for that component based on at least one second component specific input provided. For example, for a generic national grid model, the generic national grid model may be configured to receive a component specific input providing information relating to the variable: AC current frequency, from which the flow output (e.g. machine speed) may be calculated. Similar to the effort power sink models described above, a number of generic component models may be provided for each type of flow power sink wherein the component specific inputs of the second component specific inputs utilised are different. Thus, the generic powertrain component library may be adapted to provide suitable models for a variety of different powertrains where a range of inputs are available. Component specific inputs for the effort power sink models and the flow power sink models may be provided by the input file. For example, component specific inputs may be derived from the reference load of an input file. Alternatively, component specific inputs may be provided by the output of another configurable component model.

In order to configure each generic flow power sink model to reflect the performance of the specific flow power sink to be modelled, each generic flow power sink model may be configured to receive one or more second component parameters. The second component parameters provide information relating to the properties of each flow power sink component in the powertrain architecture.

The configurable second component models in the generic powertrain component library comprise a variety of different models of various power sinks which may be used in a range of different powertrains. By providing a range of different generic power sink models, the design tool can analyse a wide range of different powertrains which may meet the requirements set out in the input file. Furthermore, as each configurable second component model is arranged to receive second component parameters, each configurable second component model can be configured to model a variety of different sizes/version of each effort power sink or flow power sink.

### Configurable Third Component Models

The configurable third and fourth component models shown in FIG. 5 provide a plurality of generic coupling models which may be configured to model one or more couplings of a powertrain architecture. In general, a coupling of a powertrain architecture links two components of the powertrain together. The causality of the coupling is reflected by the type of model chosen to represent the coupling. Accordingly, a coupling for a powertrain architecture may either be modelled as an inertance coupling (i.e. an inertance coupling model), or a compliance based coupling (i.e. a compliance based coupling model).

The configurable third component models are inertance coupling models. These models include an inertance parameter associated with the coupling. Each inertance coupling model of the generic powertrain component library is configured to receive one or more effort inputs, and to calculate a resultant flow output. The configurable fourth component models are compliance based coupling models. These models include a compliance parameter associated with the coupling. Compliance based coupling models are configured to receive one or more flow inputs and to calculate a resultant effort output.

The configurable third component models shown in FIG. 5 are configurable to represent inertance couplings. As shown in FIG. 5, the generic powertrain component library may comprise E generic inertance coupling models, where E is a non-zero, positive integer.

Each generic inertance coupling model is a generic model of a coupling in a powertrain where an effort is provided to cause a flow. Examples of an inertance coupling include a flywheel in the angular mechanical domain, or a vehicle mass in the linear mechanical domain.

The generic powertrain component library includes one or models for each generic inertance coupling. That is to say, the generic powertrain component library may include a number of different models for a generic inertance coupling from which the most appropriate model may be selected. For example, in one embodiment, the generic powertrain component library may comprise: a first generic inertance coupling model, a second generic inertance coupling model, a third generic inertance coupling model etc. In total, in the embodiment of FIG. 5, there are E generic inertance coupling models.

Each generic inertance coupling model is configured to calculate a flow output for the coupling based at least one effort input. As show in FIG. 5, the effort input to an inertance coupling model may be provided by specifying a connection between the inertance coupling model and any of the A effort power source models, any of the C effort power sink models and any of the F compliance based coupling models. Prior to selection by the architecture generation module, each generic inertance coupling model does not specify any connections between the generic inertance coupling model and the effort outputs of the effort power source models, effort power sink models, and the compliance based coupling models of the generic powertrain component library. The connections of each generic inertance coupling model may be specified by the design tool, as discussed in more detail below.

A number of generic inertance coupling models for each type of inertance coupling may be provided in the generic powertrain component library. Thus, the generic powertrain component library may be adapted to provide suitable models for a variety of different powertrains with a range of different architectures.

In order to configure each generic inertance coupling model to reflect the performance of the specific inertance coupling to be modelled, each generic inertance coupling model may be configured to receive one or more third component parameters. The third component parameters provide information relating to the properties of each inertance coupling in the specific powertrain. In some cases, the generic inertance coupling model may also reflect further properties of the powertrain architecture, depending on the specific components of the powertrain connected together by, or represented by, the generic inertance coupling model.

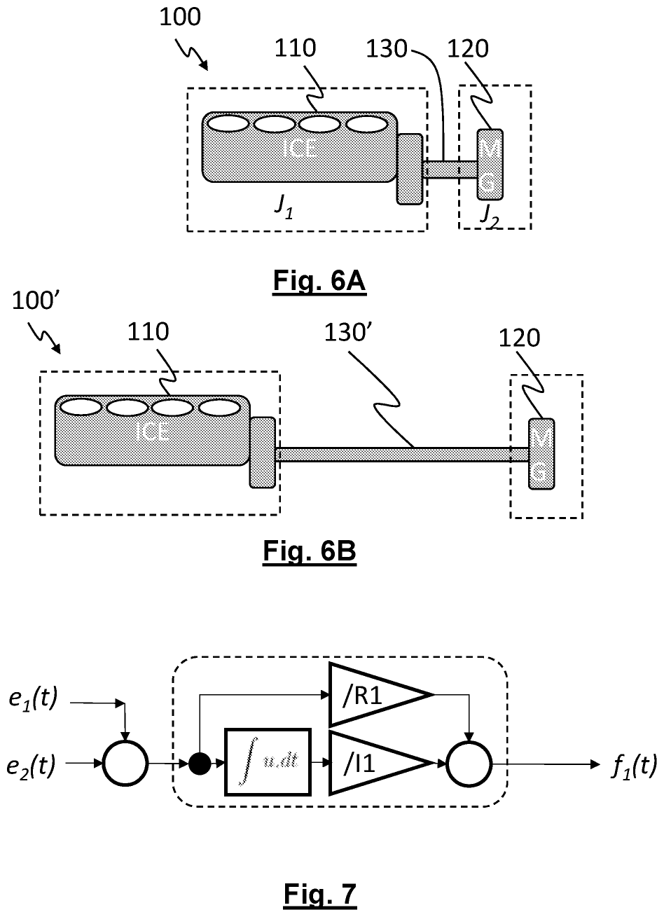

For example, FIG. 6A shows a diagram of a candidate powertrain architecture for a generator 100. The candidate powertrain architecture comprises an internal combustion engine 110, a motor generator 120, and a drive shaft 130. In the candidate powertrain architecture of FIG. 6A the internal combustion engine 110 is connected to the motor generator 120 by the drive shaft 130. The internal combustion engine 110 is configured to generate a torque which is transferred via drive shaft 130 to drive the motor generator 130 in order to generate electrical power. Accordingly, the internal combustion engine 110 sources an effort (torque) which acts on the drive shaft and the motor generator sinks an effort (torque) from the drive shaft. As such, there are two effort inputs to the drive shaft.

In the example, of FIG. 6A, the inertia associated with the internal combustion engine 110, and the inertia associated with the motor-generator 120 are both significantly greater than the inertia associated with the drive shaft 130. The drive shaft 130 may also be assumed to be rigid such that any compliance associated with the drive shaft is assumed to be negligible for the purposes of the model. Thus, in some generic inertance coupling models, the inertias of the internal combustion engine 110 and the motor generator 120 may be lumped into a single body, and modelled as a single inertia of the inertance coupling. The assumption that the drive shaft 130 is a rigid drive shaft means that there is no compliance associated with the drive shaft and thus the powertrain does not include any compliance based coupling components. For example, in some powertrains where the drive shaft 130 is relatively short, this approximation is reasonable in order to simplify the model.

FIG. 7 shows a block diagram of an example of a generic inertance coupling model, which is a generic linear inertance coupling model. The block diagram of FIG. 7 may be used to model the lumped inertias of the internal combustion engine 110 and motor generator 120 of FIG. 6A as a linear inertance coupling. As shown in FIG. 7, the generic linear inertance coupling model is configurable to receive a plurality of effort outputs. For example, the generic inertance coupling model may be configured to receive effort outputs from an effort power source model representative of the internal combustion engine 110 and an effort power sink model representative of the motor-generator 120. The generic linear inertance coupling model is a linear model as the flow output is calculated through a linear equation (integration). Of course, the third coupling models may also include other generic inertance coupling models which are non-linear (i.e. a generic non-linear inertance coupling model).

As shown in the generic linear inertance coupling model of FIG. 7, a first effort sum junction is provided. The first effort sum junction is configurable to calculate a net effort input for the generic inertance coupling model based on the effort outputs provided to it (i.e. at least one of: the effort output from one or more power source models, the effort output from one or more power sink models, and the effort output from one or more compliance based coupling models). As shown in FIG. 7, the flow output is calculated based on the net effort input calculated by the first effort sum junction.

In order to accurately model the drive shaft 130 of FIG. 6A, the generic linear inertance coupling model is also configured to receive third component parameters. The third component parameters may include information relating to an inertance for the coupling (i.e. an inertance parameter II). In the generator 100 of FIG. 6A, the inertance parameter may be based on the combined inertias of the internal combustion engine 110 and the motor-generator 120.

In some embodiments, the third component parameters may include a first resistance parameter. In some embodiments, a resistance parameter may be provided to the generic inertance coupling model to adapt the model to a component based on a resistance. For example, in the electrical domain a circuit comprising a resistor and a capacitor (but no inertance) may be modelled using by the inclusion of a generic inertance coupling model comprising a resistance parameter.

As shown in FIG. 6, the flow output of the generic inertance coupling model may be calculated in accordance with the tetrahedron of state. For the generator 100 of FIG. 6A, the inertance coupling model would be configured to calculate an angular velocity output (e.g. revolutions per minute) of the drive shaft.

### Configurable Fourth Component Models

As shown in FIG. 5, the generic powertrain component library also includes configurable fourth component models.

The configurable fourth component models shown in FIG. 5 are configurable to represent compliance based couplings. As shown in FIG. 5, the generic powertrain component library may comprise F generic compliance based coupling models, where F is a non-zero, positive integer.

Each generic compliance based coupling model is a generic model of a coupling in a powertrain where a flow is provided to cause an effort. Examples of a compliance based coupling include a drive shaft connecting synchronous motor to a propeller.

Similar to the generic inertance coupling models discussed above, the generic powertrain component library includes one or more models for each generic compliance based coupling to be modelled. That is to say, the generic powertrain component library may include a number of different configurable fourth component models for a generic compliance based coupling from which the most appropriate model may be selected. For example, in one embodiment, the generic powertrain component library may comprise: a first generic compliance based coupling model, a second generic compliance based coupling model, a third generic compliance based coupling model etc. In total, in the embodiment of FIG. 5, there are F generic compliance based coupling models.

Each generic compliance based coupling model is configured to calculate an effort output for the coupling based at least one flow input. As show in FIG. 5, the flow input to a compliance based coupling model may be provided by specifying a connection between the compliance based coupling model and any of the B flow power source models, any of the D flow power sink models and any of the E inertance coupling models. Prior to the generation of a candidate powertrain architecture, no connections are specified between the compliance based coupling models and the flow outputs of the flow power source models, the flow power sink models, and the inertance coupling models. After a candidate powertrain architecture is generated connections may be specified between at least one the effort outputs and the generic compliance based coupling model by the model generation module. The connection parameter generation module is discussed in more detail below.

A number of generic compliance based coupling models for each type of compliance based coupling may be provided in the generic powertrain component library. Thus, the generic powertrain component library may be adapted to provide suitable models for a variety of different powertrains with a range of different architectures.

In order to configure each generic compliance based coupling model to model the performance of the component being designed, each generic compliance based coupling model may be configured to receive one or more fourth component parameters. The fourth component parameters provide information relating to the properties of each compliance based coupling. In some cases, the compliance based coupling may also reflect further properties of the candidate powertrain architecture, depending on the components of the powertrain connected together by the compliance based coupling. For example, in some embodiments, the fourth component parameters may include a compliance parameter for the compliance based coupling. In some embodiments, the fourth component parameters may include a second resistance parameter. As such, a generic compliance based coupling model may be adapted to model a resistive component. The compliance based coupling models of the fourth component models are discussed in further detail with reference to the Synchronous AC Motor powertrain 200 below.

In general, the third and fourth component models of the generic powertrain component library allow the design tool to generate a model of a candidate powertrain architecture comprising X couplings. For example, in one embodiment third and fourth component parameters may be generated to define a candidate powertrain architecture with X₁ couplings, where X₁ is a positive non-zero integer. The X₁ couplings of the candidate powertrain architecture include Y₁ inertance couplings and Z₁ compliance based couplings, where Y₁ and Z₁ are both non-negative integers. Examples in which the design tool is used to generate such candidate powertrain architectures are discussed in more detail below.

The generic powertrain component library may incorporate configurable first, second, third, and fourth component models as discussed above. Each of the configurable first, second, third, and fourth component models may model a component of a powertrain. In some embodiments, the design tool may include a process compliance module that is configured to check that each of the configurable first, second, third, and fourth component models has compatible inputs and outputs with the other models in the generic powertrain component library.

In some embodiments, the generic powertrain library may include a unit test module in the generic powertrain library. The unit test module may be configured to check that each configurable first, second, third and fourth component model in the generic powertrain component library is suitable for use in the design tool. As such, the unit test module may check that the inputs and outputs for each configurable first, second, third and fourth component model are compatible with the design tool. Where the unit test module detects an issue with one or more of the configurable first, second, third and fourth component model, this may be flagged to a user for attention prior to commencement of the design tool calculation.

### Architecture Generation Module

As shown in FIG. 4, the design tool includes an architecture generation module that is configured to generate a plurality of candidate powertrain architectures based on the generic powertrain component library, and the load requirements and architecture selection constraints of the input file. Each candidate powertrain architecture generated comprises N power source models with first component specific inputs, M power sink models with second component specific inputs, and X coupling models.

In general, the architecture generation module is configured to generate all possible candidate powertrain architectures that comply with the architecture selection constraints specified. The possible permutations and combinations of the configurable first, second, third and fourth component modules in the generic component library may be identified using graph theory.

In some embodiments, the architecture generation module may include an isomorphism detection module to identify isomorphic candidate powertrain architectures (i.e. candidate powertrain architectures which are repeat candidates). For example, the isomorphism detection module is configured to detect candidate powertrain architectures which have the same relationship between the components of the candidate powertrain architectures. One example of two isomorphic candidate powertrain architectures would be an internal combustion engine (ICE) connected to a drive (BC) (i.e. (ICE-BC) and a drive BC connected to an internal combustion engine (i.e. BC-ICE). Another example would where the architecture generation module generates candidate powertrain architectures including two motor generators (MG1, MG2) located in a first and second position. The isomorphism detection module is configured to detect that a candidate powertrain architecture with MG1 in the first position and MG2 in the second position is effectively the same candidate powertrain architecture as a candidate powertrain architecture with MG2 in the first position and MG1 in the second position. In such cases, the isomorphism detection module is configured to remove one of the two candidate powertrain architectures from consideration in order to improve computational efficiency.

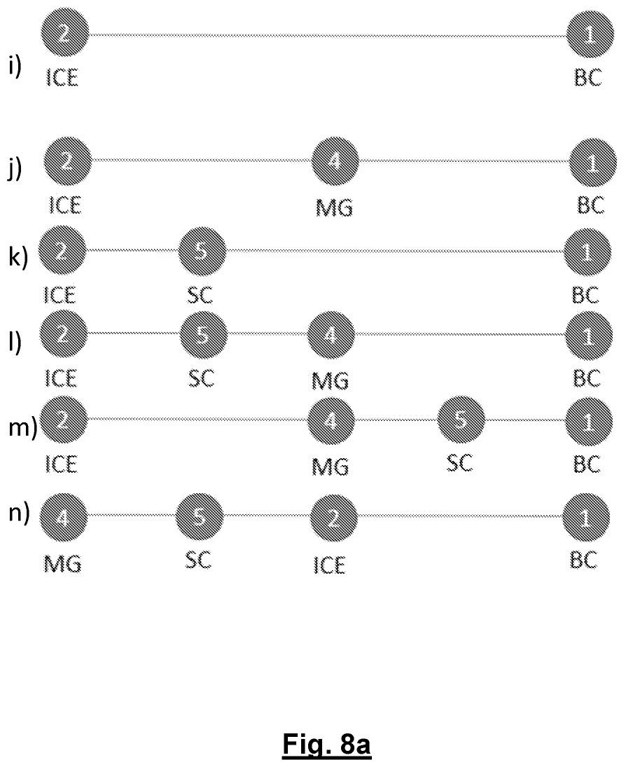

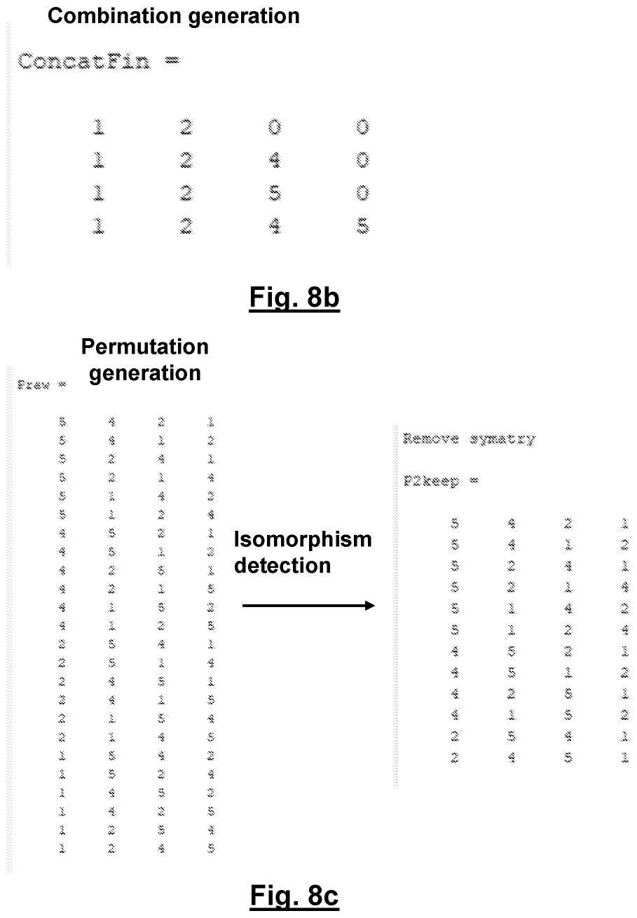

As an example, FIG. 8a shows a selection of possible candidate powertrain architectures generated from a generic powertrain component library comprising configurable first component models of an internal combustion engine (ICE) and a motor generator (MG), configurable second component models of a drive (BC), and configurable third and fourth component models of a clutch (SC).

Referring to FIG. 8a, the vertices of the graph represent configurable component models of the generic powertrain component library that represent components of a powertrain like an engine or motor/generator for example. The edges represent the connections between these components. In the example of FIG. 8a, the architecture selection constraints include information which specifies that the powertrain to be designed includes a boundary condition (e.g. drive output) and an internal combustion engine. The architecture selection constraints also specify that a motor generator and a clutch can be added or not as options for the powertrain architecture. It will be appreciated that the architecture selection constraints are specified in some detail for this example to simplify the following discussion. Of course, in other embodiments the architecture selection constraints may not be as restrictive.

In the example of FIG. 8a, the architecture generation module first considers all the possible combinations for the boundary condition 1, the internal combustion engine 2, the motor generator 4, and the clutch 5. An example of the possible combinations of the four components is shown in FIG. 8b which shows a vector of possible combinations of the four components which complies with the architecture selection constraints.

Following the generation of all the possible combinations of components, the architecture generation module may then consider all possible permutations of component connections for each combination.

For example, for the combination of the boundary condition 1, the internal combustion engine 2, the motor generator 4, and the clutch 5, there are 24 possible permutations for arranging the powertrain architecture. These permutations are shown in FIG. 8c. Once all the possible permutations are calculated, the isomorphism detection module may reduce the number of candidate powertrain architectures. For example, as shown in FIG. 8c the permutation of clutch 5-motor generator 4-internal combustion engine 2-boundary condition 1 (graph 5 4 2 1) is the same as graph 1 2 4 5.

The architecture detection module may also be configured to further remove non-physically sensible candidate powertrain architectures. For example, the powertrain architecture generation module may include rules which automatically remove permutations where a connection component model (e.g. configurable third or fourth model) is only connected to one other component. As such, permutations such as 5 4 2 1 would be removed as a clutch should be connected to two other components. Permutations which do not comply with the architecture selection constraints may also be removed. As such, the permutations shown in FIG. 8c may be further reduced to remove candidate powertrain architectures with a clutch 5 at one end and permutations where the boundary condition is not at an end.

Accordingly, the architecture generation module faced with the architecture selection constraints discussed above may generate the 6 candidate powertrain architectures shown in FIG. 8a.

### Model Generation Module

In order to evaluate each candidate powertrain architecture generated by the architecture generation module, the design tool generates a model of the candidate powertrain architecture. The model of the candidate powertrain architecture allows the design tool to assess the performance of the candidate powertrain architecture, and quantify its performance. As discussed above, each candidate powertrain architecture comprises N power source models, M power sink models, and X coupling models. The design tool comprises a model generation module that is configured to generate a connections model of the N power source models, M power sink models and X coupling models. which is representative of the candidate powertrain architecture. That is to say, the connections model represents the connections between the components (N, M, X) of the candidate powertrain architecture. The connections model comprises flow weight parameters and effort weight parameters to represent the connections.

As part of the generation of the model, the model generation module may generate a causal relationship between the N power source models, M power sink models and X coupling models. The generation of causal relationships between the N power source models and the X coupling models, and the causal relationships between the M power sink models and the X coupling models may be used to determine whether the X coupling models are represented by inertance coupling models or compliance based coupling models.

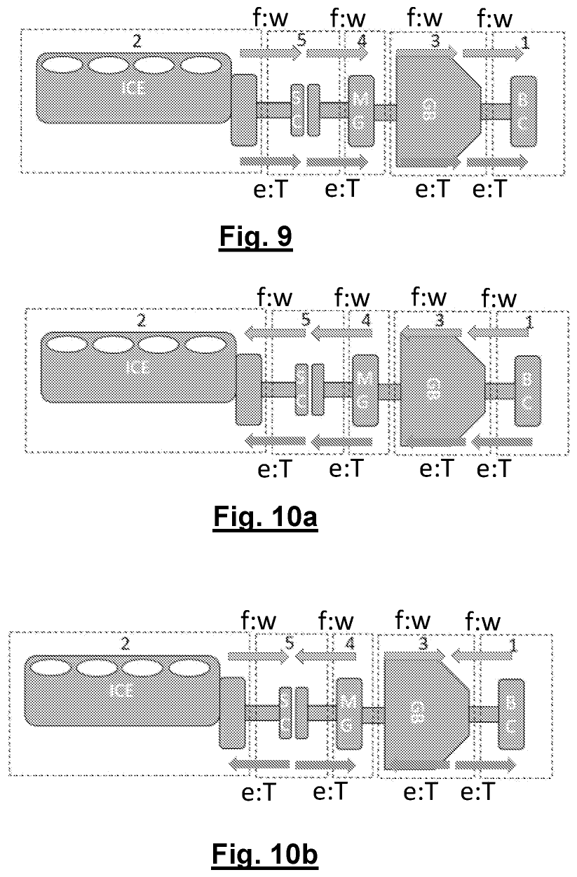

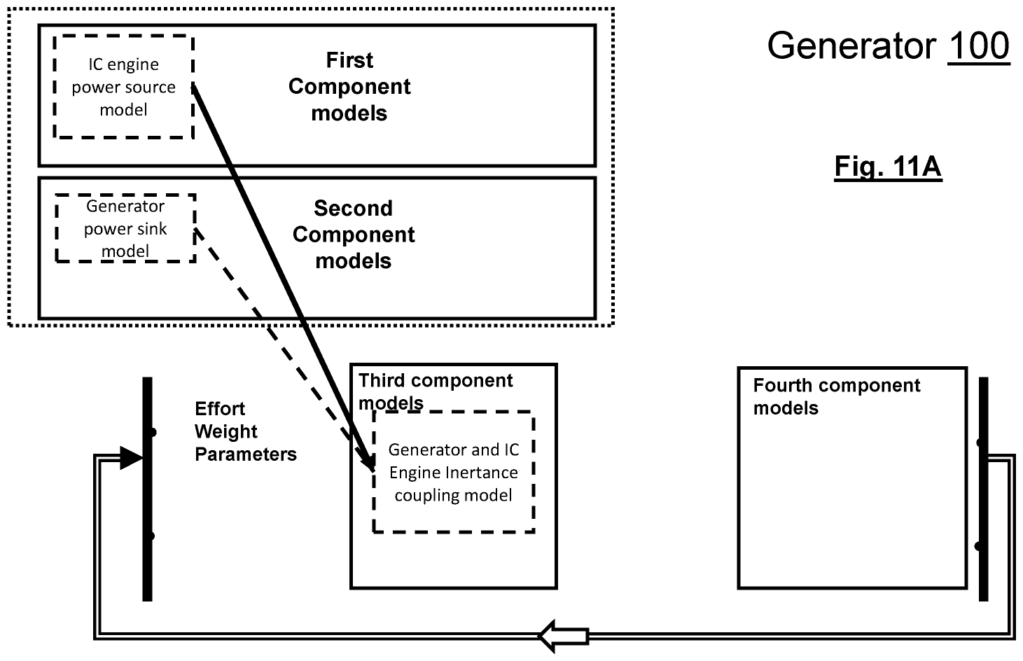

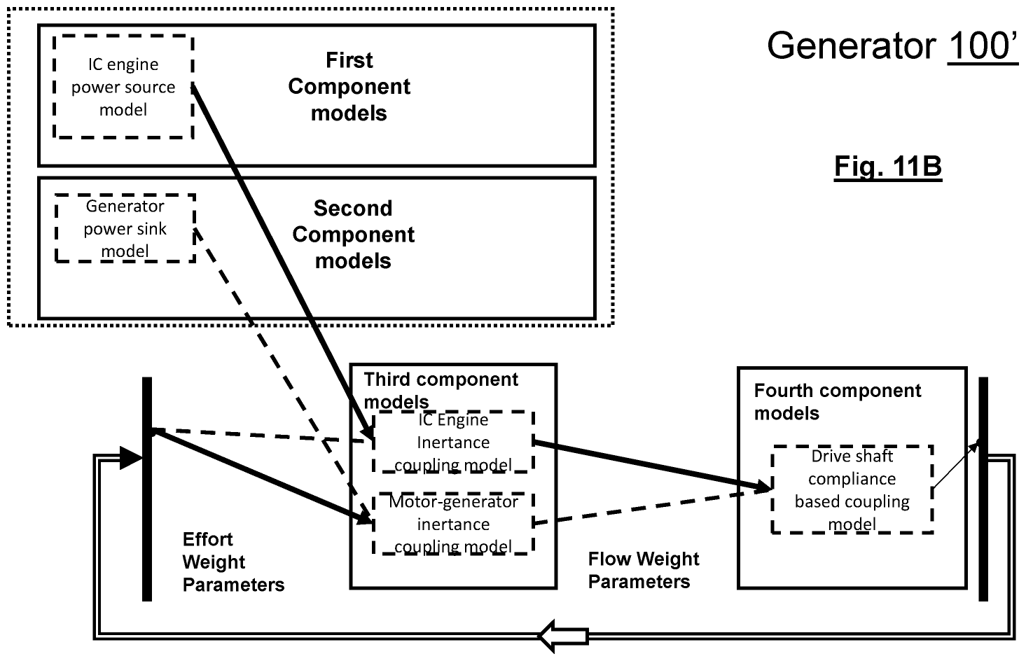

When generating the causal relationships the model generation module may generate up to three models of each candidate powertrain architecture, each with a different causal form. A first model (first causal form) may start from either the N power source models (a forward facing model). A second model (second causal form) may start from the M power sink models (a backward facing model). A third model (third causal form) may be a dynamic model with integral causality. FIGS. 9, 10a, and 10b show diagrams of a series of causal relationships generated for a candidate powertrain architecture including an internal combustion engine, a slip clutch, a motor generator, a gearbox, and a boundary condition. FIG. 9 shows an example of a forward facing model (first causal form), FIG. 10a shows an example of a backward facing model (second causal form) and FIG. 10b shows an example of a dynamic model (third causal form). The backward and forward facing models belong to the quasi static class of models. The choice of the starting point for determining causality may depend on the type of optimisation the design tool will be performing subsequently.

Any of the three causal forms may be used to generate a model of a candidate powertrain architecture suitable for use in the design tool of this disclosure. For example a forward facing causal model of the candidate powertrain architecture may be used when the design tool is configured to optimise the design based on an Equivalent Consumption Minimisation Strategy (ECMS) or a power constrained optimisation (dynamic models or backward facing models may also be used). A backward facing causal model of the candidate powertrain architecture may be used when the design tool is configured to optimise the design based on an ECMS strategy (forward facing models or dynamic models may also be used).

Whilst in the embodiment discussed above, the causality of the candidate powertrain architecture is generated by the model generation module; it will be appreciated that in other embodiments this step may be performed as part of the generation of the candidate powertrain architecture. That is to say, in some embodiments, the generation of the candidate powertrain architecture using graph theory may take into account causal considerations when selecting components to generate the candidate powertrain architecture. For example a directed graph may be used to indicate the flow of effort and flow variables in the 3 causal forms, which will have a pair of edges for each connection between vertices to represent the direction of each variable.

Turning to FIG. 5, the diagram of the generic powertrain component library shows a representation of the possible interconnections that may be defined by the effort and flow weight parameters in order to define a candidate powertrain architecture. The connections between the component models fall into one of two groups: flow connections or effort connections. Flow connections may connect a flow output of one of the first, second or third component models to a flow input of a fourth component model. As such, a flow connection may connect a flow output of a generic flow power source model, a flow output of a generic flow power sink model, or a flow output of a generic inertance coupling model to a flow input of a generic compliance based coupling mode. Effort connections may connect an effort output of one of the first, second or fourth component models to an effort input of a third component model. As such, an effort connection may connect an effort output of a generic effort power source model, an effort output of a generic effort power sink model, or an effort output of a generic compliance based coupling model to an effort input of a generic inertance coupling mode.

In FIG. 5, the possible effort connections between E generic inertance coupling models and the A generic effort power source models, C generic effort power sink models, the F compliance based couplings models are shown. FIG. 5 also shows the possible flow connections between the F generic compliance based coupling models and the B generic flow power source models, D generic flow power sink models, the E inertance coupling models.

The model generation module is configured to generate a model of the candidate powertrain architecture. The model generation module generates the model by specifying the connections between the N power source models, M power sink models and X coupling models configured from the generic powertrain component library. The model generation module specifies the connections based on flow weight parameters and effort weight parameters. As such, the model generation module determines a model architecture which is representative of the powertrain architecture based on flow weight parameters and effort weight parameters. The flow weight parameters and the effort weight parameters may be generated by the model generation module, or generated by the component parameter generation module.

The flow weight parameters define the flow connections from the flow outputs of the N power source models (i.e. the flow outputs from any flow power source models), the flow outputs of the M power sink models (i.e. the flow outputs from any flow power sink models), and the flow outputs of the inertance coupling models of the X couplings to the flow inputs of the compliance based coupling models of the X couplings of the candidate powertrain architecture. That is to say, the flow weight parameters define which of the possible flow connections are present in the candidate powertrain architecture.

The effort weight parameters define the effort connections from the effort outputs of the N power source models, the effort outputs of the M power sink models, and the effort outputs of the compliance based coupling models of the X couplings to the effort inputs of the inertance coupling models of the X coupling models of the candidate powertrain architecture. That is to say, the effort weight parameters define which of the possible effort connections are present in the candidate powertrain architecture.

Accordingly, the design tool may be configured to provide a model of candidate powertrain architecture comprising N power source models, M power sink models, and X coupling models. It will be appreciated from FIG. 5 that all of the interconnections between the generic powertrain component models of the generic powertrain component library are present in the design tool prior to the generation of the model. As such, the design tool may be implemented using a pre-compiled computer program stored in a memory. The pre-compiled computer program may be executed on a processor to generate a model for a candidate powertrain architecture on receipt of an input file providing the input parameters discussed above. The skilled person will appreciate that such a design tool is possible due to the functionality of the generic powertrain component library and the configurable component models contained therein. Specifically, the design tool is configurable to model a plurality of candidate powertrain architectures without being re-compiled as the first, second, third, and fourth component models and the connections between the component models are configurable based on respective component parameters. As such, the design tool is configurable (and reconfigurable) to model (and evaluate) a wide range of candidate powertrain architectures without the need to re-compile the design tool.

Next, the generation of a model for a number of different possible candidate powertrain architectures will be discussed. It will be appreciated that the following examples that the candidate powertrain architectures are non-limiting, and that other candidate powertrain architectures will be readily apparent to the skilled person. The following examples are provided to show how different connections between components of a powertrain may be modelled by the design tool. It will be appreciated that the input file used to generate each of the following candidate powertrain architectures may be different.

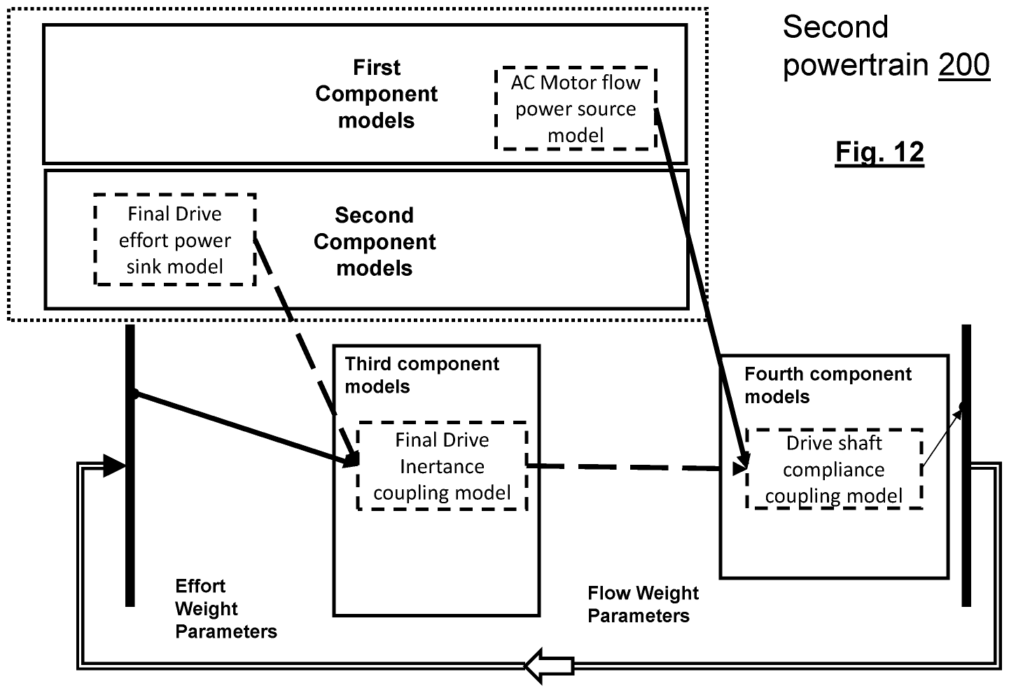

FIG. 11A shows a schematic diagram of a model of a candidate powertrain architecture generated by the design tool which is representative of a generator 100. As such, the model of the candidate powertrain architecture is a model of the generator 100 shown in FIG. 6A. As such, FIG. 11A shows the component models and connections which are utilised in the model of the candidate powertrain architecture.

As discussed above, the candidate powertrain architecture generated by the design tool include one internal combustion engine 110 that outputs a torque to drive the motor generator 120. As such, the candidate powertrain architecture comprises one effort power source (N=1). The motor generator 120 acts as a power sink and receives a torque. As such, the candidate powertrain architecture comprises one effort power sink (M=1). The internal combustion engine 110 and the motor generator 120 are connected by a drive shaft 130 (assumed to be rigid), allowing the inertance bodies 110 and 120 to be modelled as a single lumped inertance. As such, the specific powertrain comprises one coupling, which is an inertance coupling (X=1, Y=1).

The component parameter generation module provides a set of candidate parameters to configure the model as shown in FIG. 11A (discussed in more detail below). In this example, the component parameter generation module provides configurable first, second and third component parameters for the components of the candidate powertrain architecture (N=1, M=1, X=1, Y=1). As the candidate powertrain architecture does not include a compliance-based coupling (Z=0), no configurable fourth component parameters are required. As such, it will be appreciated that FIG. 11A only shows the models of the generic powertrain component library which are utilised in the model of the candidate powertrain architecture.

The model generation module also defines the connections between the models shown in FIG. 11A. In this specific powertrain, the candidate powertrain architecture is relatively simple, and so only effort connections are used to model the specific powertrain. The effort connections are specified by the effort weight parameters provided by the component parameter generation module.

Accordingly, the diagram of FIG. 11A shows how model of the candidate powertrain architecture (e.g. as shown in FIG. 6A) may be generated using component models from the generic powertrain component library.

As discussed above, in the example of FIG. 6A, the rigid drive shaft 130 is considered to be a rigid body, and as such, there is assumed to be no significant compliance associated with drive shaft 130. For example, as shown in FIG. 6A the drive shaft 130 is relatively short.

FIG. 6B shows a further example of a generator 100′ in which the drive shaft 130′ is relatively long (relative to the drive shaft 130 of FIG. 6A). In such an example, the drive shaft 130′ may have a compliance associated with it which is desirable to account for in the candidate powertrain architecture. In order to account for the compliance of the drive shaft, the inertances associated with the internal combustion engine 110 and the motor generator 120 are modelled separately. Accordingly, component models for two inertance couplings (Y=2) and one compliance-based coupling (Z=1) will need to be configured from the generic powertrain component library (X=3).

Accordingly, the diagram of FIG. 11B shows how a further candidate powertrain architecture (e.g. as shown in FIG. 6B) for a generator 100′ may be modelled, where the compliance of the drive shaft 130′ is significant. It will be appreciated that the degree to which the design tool makes assumptions about the performance of the various components of a powertrain will depend on the desired fidelity of the design tool, which may be specified in the input file as part of the architecture selection constraints.

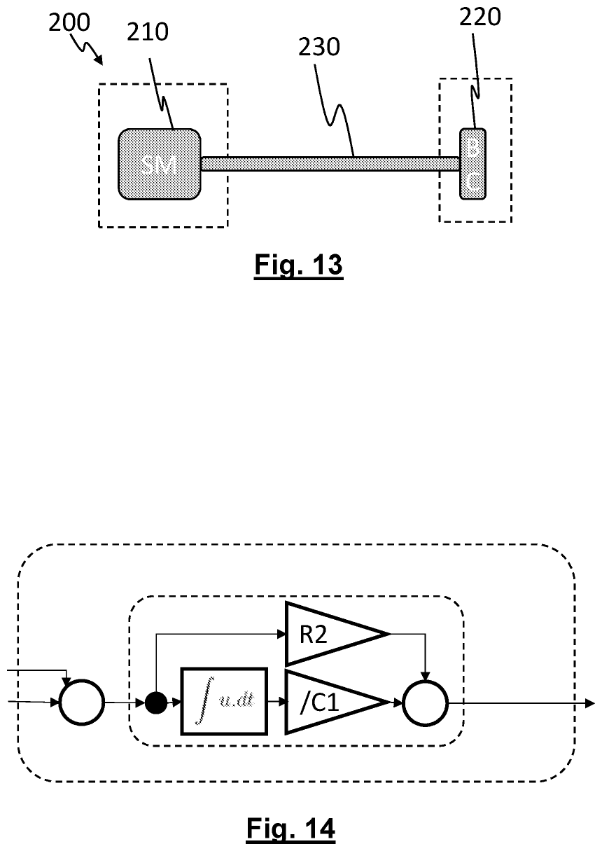

FIG. 12 shows a schematic diagram of a model of a candidate powertrain architecture which generated by the design tool. In this second example, the design tool is configured to design a second powertrain 200 comprising a synchronous AC motor 210 direct driving a load 220. The synchronous AC motor 210 is coupled to the load by a driveshaft 230. A diagram of such a powertrain is shown in FIG. 13.

The second powertrain 200 comprises a synchronous motor 210. The synchronous motor rotates with an angular velocity which is based on the frequency of the AC power supply to the synchronous motor (e.g. 50 Hz). As such, the synchronous AC motor 210 is a flow-based power source which outputs a constant flow (angular velocity). The synchronous AC motor 210 is connected to a load 220 by a driveshaft 230. The load 220 may be some machinery, (i.e. some form of inertance body) which is driven by a torque.

Accordingly, the second powertrain 200 comprises one flow power source (N=1). The load 220 acts as a power sink in this specific powertrain, and receives a torque. As such, the candidate powertrain architecture comprises one effort power sink (M=1). The load 220 also has an inertia associated with it. Accordingly, one inertance coupling is included in the powertrain model to account for the load inertia (Y=1). The AC synchronous motor 210 and the load 220 are connected by a drive shaft 230. The drive shaft receives the flow output from the synchronous motor 210 and applies a torque to the load 220. Accordingly, the design tool uses a compliance-based coupling to model the drive shaft 230 (Z=1). Thus, in the second powertrain 200, two coupling models are present (X=2).

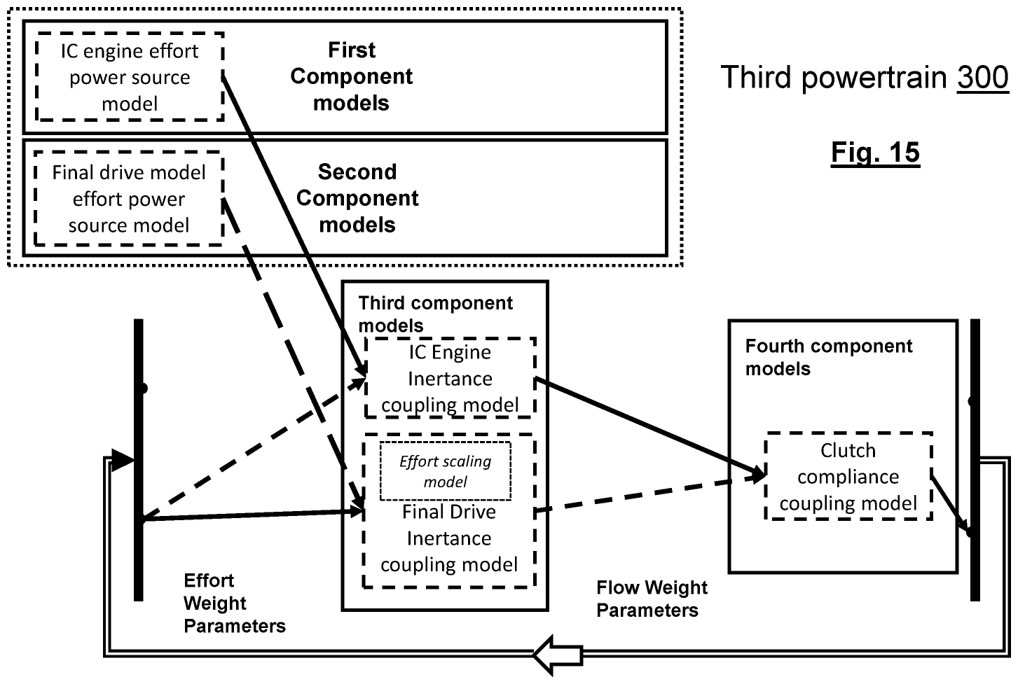

An example of a block diagram of a generic compliance-based coupling model is shown in FIG. 14. The block diagram of FIG. 14 may be used to model the drive shaft 230 of FIG. 12 as a compliance-based coupling (i.e. the generic compliance-based coupling model may be present in the generic powertrain component library). As shown in FIG. 14, the generic compliance-based coupling model is configurable to receive a plurality of flow outputs as flow inputs to the model. For example, the generic compliance-based coupling model may be configured to receive flow outputs from a flow power source model representative of the synchronous AC motor 210 and a flow output from the inertance coupling model of the drive inertia.

As shown in the generic compliance-based coupling model of FIG. 14, a first flow sum junction is provided. The first flow sum junction is configurable to calculate a net flow input for the generic compliance-based coupling model based on the flow outputs provided to it (i.e. at least one of: the flow output from one or more power source models, the flow output from one or more power sink models, and the flow output from one or more inertance coupling models). As shown in FIG. 14, the flow output is calculated based on the net effort input calculated by the first flow sum junction.

In order to model the drive shaft 230 of FIG. 13, the generic compliance-based coupling model is also configured to receive fourth component parameters. The fourth component parameters may include information relating to a compliance for the coupling (i.e. a compliance parameter C1). In the second powertrain 200 of FIG. 13, the compliance parameter may be based on the combined compliance of the synchronous AC motor 210 and the drive shaft 230. The fourth input parameter may also include information relating to a resistance for the coupling (i.e. a second resistance parameter R2). The resistance term provides an option to configure the generic compliance-based coupling based on a resistance term, rather than a compliance term.

The generic compliance-based coupling model shown in FIG. 14 is a generic linear compliance-based coupling model. As shown in FIG. 14, the effort output may be calculated from the net flow input by integrating the net flow input and scaling by the inverse of the compliance parameter C1. Of course, it will be appreciated that the generic linear compliance-based coupling model shown in FIG. 14 is only one example of a possible generic compliance-based coupling model. For example, in other embodiments, the generic powertrain component library may include fourth component models which are generic non-linear compliance-based component models. Various types of dynamic models of components are well known to the skilled person.

The component parameter generation model selects a candidate set of component parameters for the model of the second powertrain shown in FIG. 12 (N=1, M=1, X=2, Y=1, Z=1). Similar to FIGS. 11A and 11B, FIG. 12 only shows the models of the generic powertrain component library which are utilised in the candidate powertrain architecture of the second powertrain 200.

The model generation module defines the connections between the models shown in FIG. 12. For the second powertrain 200, the architecture includes a flow-based connection between the AC synchronous motor and the load 220, as well as a separate inertance coupling to represent the inertia of the load 220. As such, the second powertrain model includes both effort connections and flow connections. The effort connections are specified by the effort weight parameters, and the flow connections are specified by the flow weight parameters.

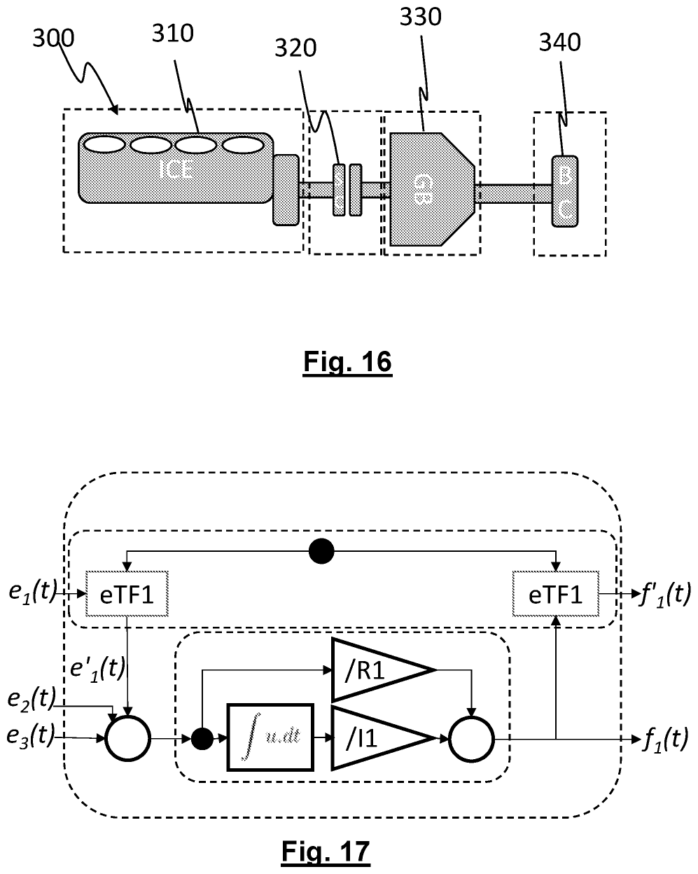

FIG. 15 shows a schematic diagram of a candidate powertrain architecture generated by the design tool. In this example, the design tool is configured to design a third powertrain 300. A schematic diagram of the candidate powertrain architecture for the third powertrain 300 is shown in FIG. 16. The candidate powertrain architecture comprises an internal combustion engine, 310, a clutch 320, a gearbox 330 and a drive output 340 (e.g. wheels). As such, the third powertrain 300 may be considered to be representative of a motor vehicle powertrain.

As with the previous examples, in order to generate the model of the candidate powertrain architecture, a candidate set of component parameters is selected by the component parameter generation module. In the third powertrain 300, an internal combustion engine is provided 310. The internal combustion engine 310 generates a torque (effort output) and also has an inertia associated with it.

The final drive output 340 receives a torque (effort output) and also has an inertance associated with it.

The design of the third powertrain 300 is a more complex (relative to the generator powertrain 100 shown in FIGS. 6A and 6B) as a clutch 320 and gearbox 340 is provided between the power source (internal combustion engine 310) and the power sink (final drive 340).

In the third powertrain 300, the design tool may assume that the clutch 320 is connected to the internal combustion engine by a relatively short drive shaft, and so it is assumed that the clutch 320 is driven at the same angular velocity as the internal combustion engine 310. The clutch applies a torque to the gearbox 330 in accordance with the angular velocity applied to it. As such, the clutch 320 may be represented as a compliance-based coupling which receives a flow from the internal combustion engine and final drive, and outputs an effort. Whilst in this candidate powertrain architecture for the third powertrain 300, the drive shaft between the internal combustion engine 310 and the clutch 320 is not modelled as a separate component, in other candidate powertrain architecture (or where a higher fidelity model is desired) the drive shaft could be modelled as a separate component.

The gearbox 330 is an example of a component which scales, or transforms the energy applied to it. In the case of a gearbox, the angular velocity output and torque output of the gearbox are scaled relative to the angular velocity input and torque input based on the gear ratio selected. To account for the presence of the gearbox 330 in the model of the candidate powertrain architecture, the third component model of the final drive inertia may include an effort scaling module. The effort scaling module allows of an inertance coupling model may be used to account for components of a powertrain which scale efforts and flows in an energy domain (e.g. a transformer or a gearbox), or even components which convert energy between different energy domains (e.g. a motor generator).

Accordingly, the Final Drive Inertia model in FIG. 15 includes an effort scaling module (Gear Box scaling module) which is configured to model the gearbox 330. A block diagram of a generic inertance coupling model including an effort scaling module is shown in FIG. 17. The effort scaling module is configurable to scale at least one of the effort inputs to the generic inertance coupling model (e.g. the effort output from one or more power source models, the effort output from one or more power sink models, and the effort output from one or more compliance-based coupling models). As shown in FIG. 17, the scaling to the effort output is applied prior to the effort output being summed at the first effort sum junction. The scaling is applied at a first scaling block (eTF1) using a first scaling parameter of provided by the component parameter generation module. In the example of the third powertrain 300, a torque output from the clutch 320 is connected to the inertance coupling model of the Final Drive 340. It will be appreciated that the actual torque applied to the Final Drive will depend on the gear ratio of the gear box. Accordingly, the first scaling parameter may scale the effort output from the compliance-based coupling model of the clutch 320 to account for the presence of the gearbox between the clutch 320 and the final drive inertia 340.

As shown in FIG. 15, a flow connection is also present between the final drive inertia 340 and the clutch 320. Due to the presence of the gearbox, the angular velocity of the final drive inertia may be scaled relative to the clutch angular velocity. Thus the flow output from the final drive inertia may also be scaled. As shown in FIG. 17, each third configurable model may include a scaled flow output. The scaled flow output may be calculated by the configurable third component model based on a first complementary scaling parameter of the provided by the component parameter generation module. In the example of the gearbox, the first complementary scaling parameter is the inverse of the first scaling parameter. Thus, the flow and effort scaling of the gearbox is modelled in the model of the candidate powertrain architecture whilst accounting for the conservation of energy.

In some embodiments, the scaling (or transform) component to be modelled may involve an amount of energy loss during the scaling process. In some models of the candidate powertrain architecture, the energy loss may be accounted for using efficiency parameters of the effort scaling model. For example, there may be some energy loss in the gearbox 330 of FIG. 16 due to friction and wear of the gearbox. To account for this energy loss, a first efficiency parameter (η₁) may be applied when calculating the any scaled quantity. The first efficiency parameter may be specified in the input file. The first efficiency parameter is less than or equal to 1.

Thus, the effort scaling module may apply the following scalings to an effort input (e(t)), and flow output (f(t)) to calculate a scaled effort input (e′(t)) and scaled flow output (f′(t)) respectively:

e′(t)=e(t)×k₁×η₁ (2)

f′(t)=f(t)×k₁⁻¹×η₁ (3)

Thus, the effort scaling module may be provided to model components of a powertrain which scale or transform efforts and flows.

In some embodiments, each effort scaling module is configurable to scale at least one of the: effort output from one or more power source models, the effort output from one or more power sink models, and the effort output from one or more compliance-based coupling models such that it is transformed from an effort in an energy domain to an effort in another energy domain. For example, a motor-generator model may include effort inputs in the electrical energy domain and calculate flow outputs in the rotational mechanical energy domain.

Returning to the example of the third powertrain in FIG. 15, it will be appreciated that the candidate powertrain architecture comprises one effort power source (N=1). The final drive 340 acts as a power sink in this specific powertrain and receives a torque. As such, the candidate powertrain architecture comprises one effort power sink (M=1). The final drive 340 also has an inertia associated with it. Accordingly, two inertance coupling models can be included in the candidate powertrain architecture to account for the final drive inertia and the inertia of the internal combustion engine (Y=2). The internal combustion engine 310 is connected to the gearbox by drive shafts either side of the clutch 320. The drive shaft receives the flow output from the internal combustion engine 310 and transfers a torque to the gearbox via the clutch 320. Accordingly, the clutch 320 and drive shafts may be modelled as a compliance-based coupling (Z=1). As discussed above, the effort (torque) input to the gearbox can be considered as a scaled effort input to the inertance coupling model of the drive inertia. Accordingly, an inertance coupling model including an effort scaling module may be used to model the gearbox and final drive inertia.

The component parameter generation module selects the candidate set of component parameters to configure the model as shown in FIG. 15. As such, the component parameter generation module select first, second, third, and fourth component parameters based on the components of the specific powertrain (N=1, M=1, X=3, Y=2, Z=1) as discussed above. Similar to FIGS. 9A, 9B, and 10, FIG. 15 only shows the models of the configurable powertrain model which are utilised in the configured powertrain model of the third powertrain 300.

The model generation module also defines the connections between the models shown in FIG. 15. For the third powertrain 300, the candidate powertrain architecture includes an effort-based connection between the internal combustion effort output and the inertance coupling model of the inertia of the internal combustion engine. This allows the powertrain model to account for the inertia of the internal combustion engine and also to account for the flow-based drive of the clutch 320.

The above example of the third powertrain 300 utilises a generic inertance coupling model comprising an effort scaling module. The generic powertrain component library may include a plurality of generic inertance coupling models.

By analogy with the generic inertance coupling model, it will be appreciated the generic powertrain component library may also include generic compliance-based coupling models comprising flow scaling models. The flow scaling models may be provided to model components which transform or scale flows to produce a corresponding scaled effort.

Thus, each configurable fourth component model may include a flow scaling module configurable to scale at least one of: the flow output from one or more power source models, the flow output from one or more power sink models, and the flow output from one or more inertance coupling models using a second scaling parameter (k₂) selected by the component parameter generation module. Similarly, the effort output calculated by the configurable fourth component model may also be scaled by a second complementary scaling parameter selected by the component parameter generation module.

Furthermore, the flow scaling module may also be configured to account for energy losses in the scaling component. Thus, each flow scaling module may be configurable to account for energy loss when scaling the at least one of: the flow output from one or more power source models, the flow output from one or more power sink models, and the flow output from one or more inertance coupling models based on a second efficiency parameter (η₂) of the selected by the component parameter generation module, and/or when scaling the effort output calculated by the configurable fourth component model based on the second efficiency parameter.

In some embodiments, each flow scaling module is configurable to scale at least one of the: flow output from one or more power source models, the flow output from one or more power sink models, and the flow output from one or more inertance coupling models such that it is transformed from a flow in an energy domain to a flow in another energy domain.

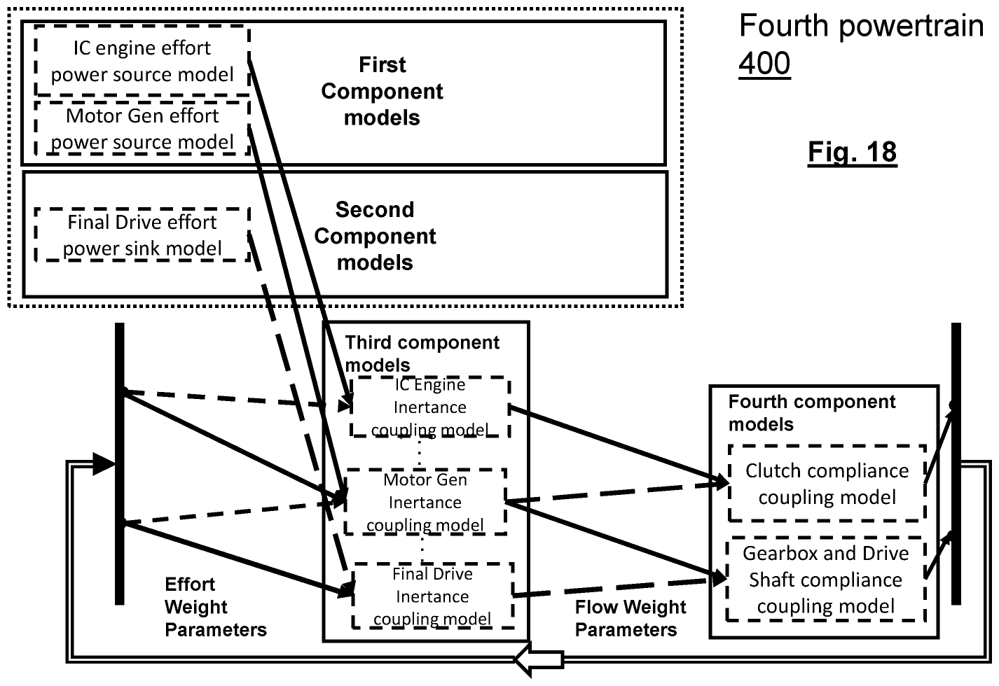

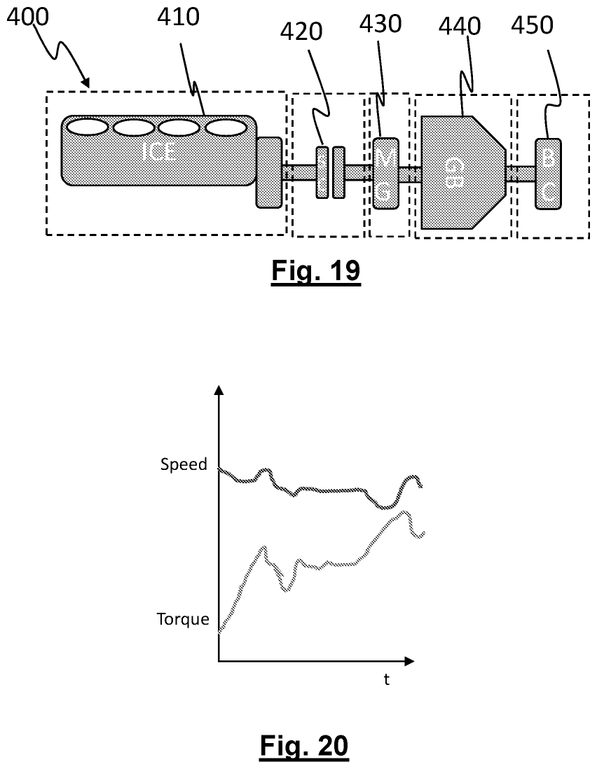

FIG. 18 shows a candidate powertrain architecture generated by the design tool. In this example, the design tool is configured to design a fourth powertrain 400. A schematic diagram of the fourth powertrain 400 is shown in FIG. 19. The fourth powertrain 400 comprises an internal combustion engine, 410, a clutch 420, a motor generator 430, a gearbox 440, and a drive output 450 (e.g. wheels). As such, the fourth powertrain 400 designed by the design tool may be considered to be representative of a motor vehicle with a hybrid powertrain.

As with the previous examples, in order to configure the configurable powertrain model to model the fourth powertrain 400, the component parameter generation module selects a candidate set of component parameters for the candidate powertrain architecture. In the fourth powertrain 400, the component parameter generation module may include component parameters to configure models representative of: an internal combustion engine effort power source, an internal combustion engine inertia, a clutch, a motor generator effort power source, a motor generator inertia, a gearbox compliance-based coupling model, a final drive power sink and a final drive inertia. The component models shown in FIG. 18 are one example of a set of component models which could be configured from the generic powertrain component library to model the fourth powertrain 400.

### Component Parameter Generation Module

As shown in the embodiment of FIG. 5, the design tool may comprise a component parameter generation module. As discussed above, each candidate powertrain architecture comprises a plurality of configurable component models (configurable first, second, third, and fourth component models). Each of the configurable component models is configurable with respective component parameters (first, second, third, and fourth component parameters) in order to model a specific component of a powertrain. The connections between each component of the candidate powertrain architecture may be defied by effort weight parameters and flow weight parameters. As such, each model of a candidate powertrain architecture may be realised by a set of parameters including first, second, third, and fourth component parameters, effort weight parameters, and flow weight parameters. In the embodiment of FIG. 5, the component parameter generation module is configured to select such sets of parameters for use in a model of the candidate powertrain architecture.

For a given candidate powertrain architecture, it will be appreciated that the values chosen for each parameter in a given set of parameters will affect the overall evaluation of the candidate powertrain architecture. As such, for a given candidate powertrain architecture the parameters within a set of parameters may be varied in order to optimise the performance of the candidate powertrain architecture. The design tool performs this optimisation by generating a plurality of different candidate sets of parameters. Each candidate set of parameters includes one or more of: candidate first component parameters, candidate second component parameters, candidate third component parameters, and candidate fourth component parameters, candidate effort weight parameters, and candidate flow weight parameters. Depending on the component model to be used, other parameters discussed above may also be selected by the component parameter generation module. For example, first scaling parameters, second scaling parameters, first efficiency parameters, second efficiency parameters etc. may also be selected by the component parameter generation module.

The component parameter generation module is configured to select values for each parameter in a set of candidate parameters. Depending on the design of powertrain to be optimised, the selection of a set of candidate parameters may be performed based one or more inputs.

In some embodiments, the component parameter generation module may select a set of candidate parameters based on information in the input file. For example, in some embodiments, the architecture selection constraints may specify ranges for values of at least some of the candidate parameters to be selected. In some embodiments, the architecture selection constraints may specify specific combinations of component parameters for one or more component model which represent “off the shelf” components to be used in a design for a powertrain. In some embodiments, the architecture selection constraints may specify ranges, or design limits for each component parameter and the effort weigh parameters and flow weight parameters from which a set of candidate parameters may be selected. In some embodiments, the architecture selection constraints may specify an initial value, or starting point for each component parameter and the effort weigh parameters and flow weight parameters (i.e. an initial set of candidate parameters) as a starting point for the design tool.

In some embodiments, the component parameter generation module may select a set of candidate parameters based on information in the generic component library. For example, where no information regarding ranges for values of component parameters is provided in the architecture selection constraints, the design tool may use values provided in the generic component library. The generic component library may specify “default” ranges for each component parameter associated with a configurable component model. As such, the generic component library may be provided with initial values for each component parameter in the generic component library from which the component parameter generation module may select a default set of candidate parameters as a starting point.

The component parameter generation module may also select parameters based on information from the model evaluation module and the powertrain design optimiser module. The model evaluation module is configured to evaluate each model of a candidate powertrain architecture and calculate a cost associated with said model. The powertrain design optimiser module may use this information in order to provide information to the component parameter generation module to select a new set of candidate parameters for a candidate powertrain architecture. As such, the design tool includes an iterative process to allow for the calculation of an optimised set of parameters for a candidate powertrain architecture.

In some embodiments, the component parameter generation module may receive information from the architecture generation module regarding the configurable first, second, third, and fourth component models in each candidate powertrain architecture for which a candidate set of parameters is to be generated. As such, the architecture generation module may output each candidate powertrain architecture to the component generation module for the generation of the candidate sets of component parameters.

### Model Evaluation Module

As shown in FIG. 5, the model generation module generates a model of a candidate powertrain architecture (M_{i,j}) based on a candidate powertrain architecture (Pᵢ) and a candidate set of parameters (Q_{i,j}). Depending on the fidelity of the design tool, the design tool may consider I different candidate powertrain architectures, with each candidate powertrain having up to J different candidate sets of parameters (e.g. where i=1, 2, 3 . . . I and j=1, 2, 3 . . . J).

For each model of a candidate powertrain architecture (M_{a,b}) the model evaluation module is configured to evaluate the performance of the model against a performance objective function and calculate a cost (C_{i,j}). The cost (C_{i,j}) calculated is specific to the candidate powertrain architecture (Pᵢ) and the candidate set of parameters (Qⱼ).

The performance objective function may be generated based on the load requirements of the input file. For example, in some embodiments where the load requirements include a reference load, the model of the candidate powertrain architecture (M_{i,j}) may be evaluated against the reference load. The performance objective function may be configured to evaluate the extent to which the model of the candidate powertrain architecture (M_{i,j}) can provide the reference load. An example of a reference load that may be provided as part of the input file is shown in graph form in FIG. 20. As shown in FIG. 20, the reference load includes data for a speed variable and a torque variable of a drive output of a powertrain. As such, the reference load of FIG. 20 requires the generation of a backwards facing model of the candidate powertrain architecture. Of course, in other embodiments, the reference load could be expressed in terms of load requirements of a power source for the powertrain, in which case a forward facing model may be used. Alternatively, a dynamic model may be used by the generation of a suitable controller to “drive” the powertrain at the desired reference load. As such, the speed can be controlled by a Proportional-Integral (PI) controller having an input of speed error and outputting a torque (or fuel signal) to the power source(s) of the model of the candidate powertrain architecture. Effectively, a controller can be provided to generate component specific inputs for configurable component models of a candidate powertrain architecture. As such, the reference load used (and any component specific inputs provided) may depend on the type of powertrain being designed by the design tool, and the design requirements specified.

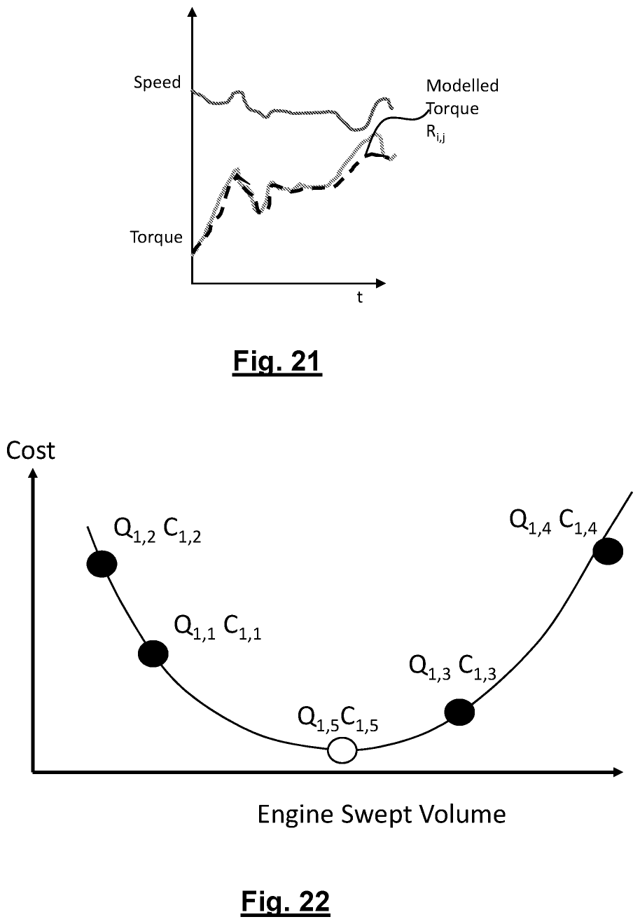

The model evaluation model is configured to model the response (R_{i,j}) of each model of the candidate powertrain architecture (M_{i,j}) to the reference load. An example of such a response is shown in FIG. 21. In FIG. 21, the model evaluation module uses the speed variable of the reference load as an input and calculate the resulting torque response that would be output to the drive of the powertrain.

The response of each model of the candidate powertrain architecture (R_{i,j}) may be calculated by the model evaluation module. In some embodiments, calculation of the response of the model of the candidate powertrain architecture (R_{i,j}) to the reference load may also comprise generation of a controller for the candidate powertrain architecture. Various control strategies may be used to control the model of the candidate powertrain architecture (M_{i,j}) in order to deliver the reference load.

In order to evaluate the extent to which the response of the model of a candidate powertrain architecture (R_{i,j}) meets reference load, the model evaluation model is configured to evaluate the response of the model against a performance objective function. The performance objective function is configured to calculate a cost (C_{i,j}) based on the response (R_{io,j}) of the model of the candidate powertrain architecture to the reference load.

In some embodiments, the performance objective function defines one or more objectives that the response of the model of a candidate powertrain architecture should aim to meet. The performance objective function calculates a cost (C_{i,j}) associated with each objective in order to evaluate the overall performance of each candidate powertrain architecture.

As an example, the performance objective function may one or more objectives which are system objectives. A system objective may be a physical limitation imposed by design tool on the design space for the powertrain. For example, for a powertrain design comprising a motor generator and a gearbox, the candidate powertrain architecture model have system objectives associated with variables including the motor generator torque (T_{MG}(t)) and the gearbox rotation speed (ω(t)). It will be appreciated that there are physical limits in the amount of torque the motor generator can output or receive. There may also be physical limits on the speed of rotation of the gearbox. As such, the system objectives may be objectives which are independent of the reference load. The performance objective function may specify one or more system objectives for each variable to avoid arriving at design solutions which exceed these physical limits. In some embodiments, a system objective may be modelled as a hyperbolic function. A cost parameter may be specified by the load requirements of the input file to calculate a cost associated with a physical capability of the powertrain to be designed. For example, a system objective for a variable gearbox rotation speed may be provided based on a limit α, which specifies a maximum gearbox rotation speed. The cost calculated by the performance objective function may rise asymptotically as the limit α is approached. As such, the system objective may be calculated using a hyperbolic function. The limit α may be specified as one of the load requirements of the input file. For example, a system objective (J_{GBspeed}) based on the gearbox rotation speed (ω(t)) may be:

J_{GBSpeed}=1/(α−ω(t))

The performance objective function may also include one or more objectives which are response objectives. Response objectives may calculate a cost associated with a difference between the response and the reference load. A response objective may be modelled as parabolic function which is configurable with a cost parameter. An example of a response objective is minimising torque error. Such forms of response objective may be represented by a function having a weighted square law relationship. For example, for the variable torque error (Reference Torque−Modelled Torque), a response objective constraint (J_{Torque_error}) may be specified by a cost parameter β, which specifies a weighting to be applied to this response objective. Accordingly, a response objective, in this example for torque error may take the form:

J_{Torque_error}=β*(Reference Torque−Modelled Torque)\hat{ }2 (5)

The performance objective function calculates a cost based on a sum of the costs associated with each system objective and each response objective. The performance objective function of the model evaluation module then outputs the cost (C_{i,j}) associated with the model of the candidate powertrain architecture to the powertrain design optimiser module.

### Powertrain Design Optimiser Module

The powertrain design optimiser module is configured to calculate an optimised set of parameters (Q_{i,Opt}) for each candidate powertrain architecture (Pᵢ). The powertrain design optimiser module performs this calculation by optimising the candidate first, second, third, and fourth component parameters based on the cost associated with the candidate powertrain architecture and the candidate first, second, third, and fourth component parameters. The powertrain design optimiser module may also optimise other parameters associated with each candidate powertrain architecture (e.g. the effort and flow weight parameters). Increasing the number of parameters to be optimised increases the computational complexity of the design tool. Accordingly, the number of parameters to be optimised may be selected based on the desired fidelity of the model.

The powertrain design optimiser module is configured to calculate an optimised set of parameters Q_{i,Opt} for each of the A candidate powertrain architectures. Each optimised set of parameters Q_{i,Opt} a will have a cost associated with it (C_{i,Opt}). The design tool then outputs an optimised powertrain architecture (P_{Opt,Opt}) having optimised first, second, third and fourth component parameters based on the optimised costs calculated for each candidate powertrain architecture. As such, the powertrain design optimiser module collates the costs calculated for each iteration of the design tool, and based on the costs calculated selects the best performing candidate powertrain architecture and candidate set of parameters as the optimised powertrain architecture and optimised set of parameters as the final design.

The powertrain design optimiser module provides a searching strategy for the design tool to aid the selection of candidate sets of parameters. As such, the powertrain design optimiser module is configured to optimise the set of parameters (Q) for each candidate powertrain architecture (Pᵢ). Various searching strategies for optimisers are known to the skilled person. Accordingly, the powertrain design optimiser module may include one or more searching algorithms which may be configured to search the cost space (C_{i,j}) defined by the performance objective function in order to identify an optimised solution (e.g. a minimum in the cost space). For example, the powertrain design optimiser module may use mixed integer programming and/or a stochastic programming strategy to search the cost space in order to find an optimised point Q_{i,Opt} for the i^{h} candidate powertrain architecture.

In the example of FIG. 22, the results of a searching strategy performed by the design tool are shown as points in the cost space. FIG. 22 shows a simplified in which only a single parameter is varied (engine swept volume) with all other parameters kept constant. The searching strategy performed by the design tool includes a stratified sample process and a line searching process to try to identify a minimum point whilst avoiding solutions, which are a local minima, but not a global minima. In some embodiments, the cost space may be multidimensional search space, wherein the number of dimensions corresponds to the number of parameters to be optimised. It will be appreciated that the single dimensional example of FIG. 22 can be extended to multi-dimensional costs spaces.

In the example cost space of FIG. 22, the different values (j=1, 2, 3, 4, 5) for the parameter engine swept volume are generated for the i=1 candidate powertrain architecture (Q_{1,1} to Q_{1,5}). The cost space (C_{i,j}) effectively defines every possible combination of parameters in the set of parameters Q that may be evaluated by design tool. The powertrain design optimiser module is configured to generate a search strategy and feedback information to the candidate parameter selection module in order to generate addition candidate sets of parameters.

As shown in FIG. 22, a stratified sample is initially performed of the cost space to ensure that the sets of candidate parameters (Q_{1,1} to Q_{1,4}) are distributed across the cost space. As such, it will be appreciated that a stratified sample may provide a more even distribution of set of candidate sets of parameters across the cost space than a purely random sample. In the example of FIG. 22, four stratified samples are taken to illustrate this concept.

Various methods of performing a stratified sample of a multidimensional search space are known to the skilled person. In one embodiment of the disclosure, the powertrain design optimiser module performs a Latin hypercube sample of the cost space. In other embodiments, an orthogonal sampling method may be used to determine a stratified sample, or any other suitable stratified sampling method which provides a distribution of sets of candidate sets of parameters in the cost space.

As shown in FIG. 22, a plurality of points are indicated on the cost surface. Each point represents a candidate set of parameters (Q_{1,1}, Q_{1,2}, Q_{1,3}Q_{1,4}) for the i=1 candidate powertrain architecture) and the associated cost (C_{1,1}, C_{1,2}, C_{1,3}C_{1,4}).

Following performing a stratified sampling searching strategy, the powertrain design optimiser module may in some embodiments select the lowest cost point as the optimised set of parameters. In some embodiments, the powertrain design optimiser module may also perform a line searching process as a second step (in a multidimensional case along a unit vector). In the second step, the powertrain design optimiser module determines a search line in the cost space which spans a first cost minima based on the costs generated by the stratified sample.

In one embodiment, the search line is determined based on the two candidate sets of parameters with the lowest costs. As such, a search vector is determined as a vector in the cost space along a line between the two sets of candidate parameters with the lowest costs (Q_{1,3} and Q_{1,1} in FIG. 22). The purpose of determining a search vector is to provide a direction along which to further search for a minima in order to identify an optimised set of parameters (Q_{1,Opt}) which have the lowest associated cost (C_{1,Opt}).

Various methods for determining if a minima of a function (i.e. the cost function) lies between two points on a line are known to the skilled person. One method for checking if a minima lies along a search line is to evaluate the cost function at a third point (x1) along the search line (i.e. between the two sets of candidate parameters Q with the lowest costs on the search line). If the third point evaluated has a cost which is lower than either of the two end points of the search line, this indicates that a minima lies on the search line between the two end points. In the event that it is determined that a minima is not present along the search line, the end points of the search line may be extended along the search vector in the cost space and re-evaluated. This process may be iterated until a search line straddling a minima is found.

For example, in the cost space of FIG. 22, a plurality of points are evaluated along a search line in the cost space in order to identify an optimised set of parameters (Q_{1,5}) for the i=1 candidate powertrain architecture. In the example of FIG. 22, the search line is aligned with engine swept volume dimension, as only one parameter is varied. Of course in multidimensional cases, the search line generated may not be aligned with a single parameter of the set of parameters (Q).

It will be appreciated that the searching strategy of the powertrain design optimiser module may also be configured to work with the architecture generation module. As such, powertrain design optimiser module may also be used to inform a searching strategy for the generation of candidate powertrain architectures. As such, in some embodiments, the powertrain design optimiser module may be used to select samples from a multidimensional design space of different candidate powertrain architectures. Such a searching strategy may be appropriate where the number of possible candidate powertrain architectures is sufficiently large that the computational complexity becomes excessive. Of course, in other embodiments where the number of possible candidate powertrain architectures is more limited (e.g. such as in FIG. 8a), the design tool may evaluate every possible candidate powertrain architecture.

### INDUSTRIAL APPLICABILITY

According to this disclosure, a computer-implemented design tool for designing a powertrain, and a method of designing a powertrain with a computer implemented design tool is provided. The design tool is configured to design any specific powertrain falling within the class of generic powertrains comprising N power sources, M power sinks, and X couplings, where (N, M and X are positive, non-zero integers).

Accordingly, the design tool may be configured to design powertrains for a variety of systems including, but not limited to: motor vehicles, electric vehicles, hybrid vehicles, marine vessels, electrical power generation equipment, manufacturing equipment, and aviation.

The design tool is configurable develop a design solution to a design problem on receipt of an input file comprising load requirements and architecture selection constraints. Accordingly, the design tool of this disclosure may be reliably and efficiently configured to design powertrains for a wide range of different technical fields using the same process. As such, the design tool may be easy to operate as the design problem can be updated by changing the input file, rather than by changing the models and internal coding of the various modules of the design tool.

Furthermore, the design tool allows for a large number of possible solutions to be considered in an efficient manner. The design tool may also evaluate candidate powertrain architectures in a bias-free manner. Thus, the design tool may generate design solutions which may not have traditionally been considered by a user working with pre-conceived biases.

Accordingly, the design tool may be provided to design to a range of powertrain systems in a reliable and efficient manner, thus avoiding extensive human effort, simulation, software build and testing costs associated with traditional design methods.

1. A method for designing a powertrain using a design tool implemented on a computer, the method comprising:
providing an input file to the design tool, the input file comprising architecture selection constraints and load requirements for the powertrain to be designed;
providing a generic powertrain component library comprising
a plurality of configurable first component models from which N power source models are configurable based on first component parameters, wherein
each first component model is configured to receive at least one of a plurality of first component specific inputs and to calculate an effort output or flow output based on the at least one of the plurality of first component specific inputs;
a plurality of configurable second component models from which M power sink models are configurable based on second component parameters, wherein
each second component model is configured to receive at least one of a plurality of second component specific inputs and to calculate an effort output or flow output based on at least one of the plurality of second component specific inputs; and
a plurality of configurable third component models from which at least one inertance coupling model is configurable based on third component parameters, wherein
each third component model is configured to receive a plurality of effort inputs and to calculate a flow output based on the effort inputs, and
a plurality of configurable fourth component models from which a compliance based coupling model is configurable based on fourth component parameters, wherein
each fourth component model is configured to receive a plurality of flow inputs and to calculate an effort output;
wherein X coupling models may be configured from the third and fourth component models,
wherein the design tool generates a plurality of candidate powertrain architectures based on the generic powertrain component library, and the load requirements and architecture selection constraints of the input file, each candidate powertrain architecture comprising N power source models with first component specific inputs, M power sink models with second component specific inputs, and X coupling models;
wherein for each candidate powertrain architecture:
i) the design tool generates a connections model of the N power source models, M power sink models and X coupling models which is representative of the candidate powertrain architecture comprising flow weight parameters and effort weight parameters, wherein
the flow weight parameters define any flow connections from the flow outputs of the N power source models, the flow outputs of the M power sink models, and the flow outputs of the inertance coupling models of the X couplings to the flow inputs of the compliance based coupling models of the X couplings of the model architecture; and
the effort weight parameters define any effort connections from the effort outputs of the N power source models, the effort outputs of the M power sink models, and the effort outputs of the compliance based coupling models of the X couplings to the effort inputs of the inertance coupling models of the X coupling models of the model architecture;
ii) the design tool selects candidate first, second, third and fourth component parameters for the N power source models, M power sink models, and X coupling models of the candidate powertrain architecture, and
generates a model of the candidate powertrain architecture based on the candidate first, second, third and fourth component parameters, the N power source models, M power sink models and X coupling models, and the connections module;
iii) the design tool evaluates the model of the candidate powertrain architecture based on the load requirements of the input file and generates a cost associated with the candidate powertrain architecture and the candidate first, second, third, and fourth component parameters; and
iv) the design tool calculates optimised first, second, third and fourth component parameters for the candidate powertrain architecture by optimising the candidate first, second, third, and fourth component parameters based on the cost associated with the candidate powertrain architecture and the candidate first, second, third, and fourth component parameters; and
wherein the design tool outputs an optimised powertrain architecture having optimised first, second, third and fourth component parameters based on the optimised first, second, third and fourth component parameters of each candidate powertrain architecture.

2. The method according to claim 1, wherein
the load requirements of the input file comprise a reference load for the powertrain.

3. The method according to claim 1, wherein
the architecture selection constraints of the input file comprise one or more of: a minimum number of power sources constraint, a maximum number of power sources constraint, a minimum number of power sinks constraint, a maximum number of power sinks constrain, a minimum number of couplings constraint, and a maximum number of couplings constraint.

4. The method according to claim 3, wherein
each configurable third component model comprises a first effort sum junction configurable to calculate a net effort input for the third component model based on at least one of: the effort output from one or more power source models, the effort output from one or more power sink models, and the effort output from one or more compliance based coupling models,
wherein the flow output is calculated based on the net effort input.

5. The method according to claim 4, wherein
each configurable third component model comprises an effort scaling module configurable to scale at least one of: the effort output from one or more power source models, the effort output from one or more power sink models, and the effort output from one or more compliance based coupling models based on a first scaling parameter and to scale the flow output calculated by the configurable third component model by a first complementary scaling parameter,
wherein the first scaling parameter is provided by the design tool when generating the model of each candidate powertrain architecture; and
the design tool calculates an optimised first scaling parameter based on the cost associated with the candidate powertrain architecture and the candidate first, second, third, and fourth component parameters.

6. The method according to claim 4, wherein the net effort input calculated by the first effort sum junction is based on efforts in the same energy domain.

7. The method according to claim 1, wherein
each configurable fourth component model comprises a first flow sum junction configured to calculate the net flow input for the fourth component model based at least one of: the flow output from one or more power source models, the flow output from one or more power sink models, and the flow output from one or more inertance coupling models.

8. The method according to claim 7, wherein
each configurable fourth component model comprises a flow scaling module configurable to scale at least one of: the flow output from one or more power source models, the flow output from one or more power sink models, and the flow output from one or more effort based coupling models based on a second scaling parameter and to scale the effort output calculated by the configurable fourth component model by a second complementary scaling parameter,
wherein the second scaling parameter is provided by the design tool when generating the model of each candidate powertrain architecture; and
the design tool calculates an optimised second scaling parameter based on the cost associated with the candidate powertrain architecture and the candidate first, second, third, and fourth component parameters.

9. The method according to claim 1, wherein
generating a candidate powertrain architecture comprises:
selecting a set of first, second, third and/or fourth component models from the generic component library based on the architecture selection constraints;

10. The method according to claim 1, wherein
generating a connections model of the N power source models, M power sink models and X coupling models for each candidate powertrain architecture comprises
generating a causal relationship between the N power source models, M power sink models and X coupling models.

11. The method according to claim 1, wherein
the design tool optimises the candidate first, second, third, and fourth component parameters using a stratified sampling strategy.

12. The method according to claim 11, wherein
the design tool further optimises the candidate first, second, third, and fourth component parameters following the stratified sampling strategy using a line search strategy.

13. The method according to claim 2, wherein
the design tool calculates a response of the model of the candidate powertrain architecture to the reference load and evaluates the response of the model of the candidate powertrain architecture based on the load requirements.

14. A computer-implemented design tool for designing a powertrain,
the design tool is configured to receive an input file, the input file comprising architecture selection constraints and load requirements for the powertrain to be designed;
the design tool comprising a generic powertrain component library comprising:
a plurality of configurable first component models from which N power source models are configurable based on first component parameters, wherein
each first component model is configured to receive at least one of a plurality of first component specific inputs and to calculate an effort output or flow output based on the at least one of the plurality of first component specific inputs;
a plurality of configurable second component models from which M power sink models are configurable based on second component parameters, wherein
each second component model is configured to receive at least one of a plurality of second component specific inputs and to calculate an effort output or flow output based on at least one of the plurality of second component specific inputs; and
a plurality of configurable third component models from which at least one inertance coupling model is configurable based on third component parameters, wherein
each third component model is configured to receive a plurality of effort inputs and to calculate a flow output based on the effort inputs, and
a plurality of configurable fourth component models from which a compliance based coupling model is configurable based on fourth component parameters, wherein
each fourth component model is configured to receive a plurality of flow inputs and to calculate an effort output;
wherein X coupling models may be configured from the third and fourth component models,
the design tool comprising an architecture generation module, the architecture generation module configured to generate a plurality of candidate powertrain architectures based on the generic powertrain component library, and the load requirements and architecture selection constraints of the input file, each candidate powertrain architecture comprising N power source models with first component specific inputs, M power sink models with second component specific inputs, and X coupling models;
wherein for each candidate powertrain architecture:
i) the architecture generation module is configured to generate a connections model of the N power source models, M power sink models and X coupling models which is representative of the candidate powertrain architecture comprising flow weight parameters and effort weight parameters, wherein
the flow weight parameters define any flow connections from the flow outputs of the N power source models, the flow outputs of the M power sink models, and the flow outputs of the inertance coupling models of the X couplings to the flow inputs of the compliance based coupling models of the X couplings of the model architecture; and
the effort weight parameters define any effort connections from the effort outputs of the N power source models, the effort outputs of the M power sink models, and the effort outputs of the compliance based coupling models of the X couplings to the effort inputs of the inertance coupling models of the X coupling models of the model architecture;
ii) the design tool is configured to select candidate first, second, third and fourth component parameters for the N power source models, M power sink models, and X coupling models of the candidate powertrain architecture, and
is configured to generate a model of the candidate powertrain architecture based on the candidate first, second, third and fourth component parameters, the N power source models, M power sink models and X coupling models, and the connections module;
iii) a model evaluation module of the design tool is configured to evaluate the model of the candidate powertrain architecture based on the load requirements of the input file and generates a cost associated with the candidate powertrain architecture and the candidate first, second, third, and fourth component parameters; and
iv) the design tool is configured to calculate optimised first, second, third and fourth component parameters for the candidate powertrain architecture by optimising the candidate first, second, third, and fourth component parameters based on the cost associated with the candidate powertrain architecture and the candidate first, second, third, and fourth component parameters; and
wherein the design tool is configured to output an optimised powertrain architecture having optimised first, second, third and fourth component parameters based on the optimised first, second, third and fourth component parameters of each candidate powertrain architecture.

15. The computer-implemented design tool according to claim 14, wherein
the design tool is configured to received load requirements of the input file including a reference load.

16. The computer-implemented design tool according to claim 15, wherein
the model evaluate module is configured to evaluate the model of the candidate powertrain architecture including calculating a response of the model of the candidate powertrain architecture to the reference load and evaluating the response of the model of the candidate powertrain architecture based on the load requirements.

17. The computer-implemented design tool according to claim 14, wherein
the design tool is configured to optimise the candidate first, second, third, and fourth component parameters using a stratified sampling strategy.

18. The computer-implemented design tool according to claim 14, wherein
the design tool is configured to further optimise the candidate first, second, third, and fourth component parameters following the stratified sampling strategy using a line search strategy.

19. The computer-implemented design tool according to claim 14, wherein
the design tool is configured to received architecture selection constraints of the input file comprising one or more of: a minimum number of power sources constraint, a maximum number of power sources constraint, a minimum number of power sinks constraint, a maximum number of power sinks constrain, a minimum number of couplings constraint, and a maximum number of couplings constraint.

20. The computer-implemented design tool according to claim 14, wherein
the design tool being configured to generate a connections model of the N power source models, M power sink models and X coupling models for each candidate powertrain architecture comprises
generating a causal relationship between the N power source models, M power sink models and X coupling models.
